(19) United States
(12) Patent Application Publication
(10) Pub. No.: US 2026/0260547 A1
(43) Pub. Date: Sep. 3, 2026

(54) ELECTRONIC GAMING SYSTEMS INCLUDING BOLT-ON SYMBOLS FOR TRIGGERING BONUS MAP GAMES

(71) Applicant: Aristocrat Technologies, Inc., Las Vegas, NV (US)

(72) Inventors: Erick Ching, Cedar Park, TX (US); Rogelio Decasa, JR., Renton, WA (US); Ridhima Jain, New Delhi, IN (US); Jennifer Mizzi, Ewa Beach, HI (US); Vikas Saini, Haryana (IN)

(21) Appl. No.: 19/067,548

(22) Filed: Feb. 28, 2025

(51) Int. Cl. G07F 17/32

(52) U.S. Cl. CPC G07F 17/3267; G07F 17/3213

(57) ABSTRACT

An electronic gaming system includes at least one memory for storing instructions, and a game controller including a processor(s). When the instructions are executed by the processor(s), the processor(s) is configured to display a base reel game including reels displaying game symbols, and/or bolt-on symbol(s) associated with one of the game symbols. The bolt-on symbols are associated with instructions stored in the memory subsequent to instructions associated with the base reel game. The processor(s) is also configured to determine that an outcome of the base reel game triggers a map game corresponding to the bolt-on symbol(s). Additionally, the processor(s) is configured to display the map game including a plurality of bonus games or a prize value, define a map game outcome, and in response to defining the map game outcome, display one of the plurality of bonus games or the prize value included in the defined map game outcome.

### TECHNICAL FIELD

The field of disclosure relates generally to electronic gaming, and more specifically, to electronic gaming systems, programs, and methods that include bolt-on symbols added to game symbols of an existing game to incorporate a distinct, bonus map game within the existing game.

### BACKGROUND

Electronic gaming machines or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Notably, some games may include an element of skill on the part of the player and are therefore not entirely random.

### BRIEF DESCRIPTION

In one aspect, an electronic gaming system includes at least one memory for storing instructions, and a game controller in communication with the at least one memory. The game controller includes at least one processor, wherein when the instructions are executed by the at least one processor, the at least one processor is configured to: cause to be displayed on a display device a base reel game including a plurality of reels displaying at least one of: (i) a plurality of game symbols, or (ii) at least one bolt-on symbol associated with one of the plurality of game symbols, the bolt-on symbols associated with instructions stored in the at least one memory subsequent to instructions associated with the base reel game; determine that an outcome of the base reel game triggers a map game corresponding to the at least one bolt-on symbol displayed on one of the plurality of reels, the map game associated with the instructions stored in the at least one memory subsequent to instructions associated with the base reel game; cause to be displayed on the display device the map game including a plurality of map spaces, each of the plurality of map spaces associated with one of a plurality of bonus games or a prize value; define a map game outcome including one map space of the plurality of map spaces of the map game; and in response to defining the map game outcome, cause to be displayed on the display device one of the plurality of bonus games or the prize value associated with the map space of the plurality of map spaces included in the defined map game outcome.

In another aspect, a method of electronic gaming implemented on an electronic gaming machine includes: causing to be displayed on a display device a base reel game including a plurality of reels displaying at least one of: (i) a plurality of game symbols, or (ii) at least one bolt-on symbol associated with one of the plurality of game symbols, the bolt-on symbols associated with instructions stored in the at least one memory subsequent to instructions associated with the base reel game; determining that an outcome of the base reel game triggers a map game corresponding to the at least one bolt-on symbol displayed on one of the plurality of reels, the map game associated with the instructions stored in the at least one memory subsequent to instructions associated with the base reel game; causing to be displayed on the display device the map game including a plurality of map spaces, each of the plurality of map spaces associated with one of a plurality of bonus games or a prize value; defining a map game outcome including one map space of the plurality of map spaces of the map game; and in response to defining the map game outcome, causing to be displayed on the display device one of the plurality of bonus games or the prize value associated with the map space of the plurality of map spaces included in the defined map game outcome.

In an additional aspect, a non-transitory computer-readable storage medium with instructions stored thereon is provided. The instructions, in response to execution by at least one processor, cause the at least one processor to: cause to be displayed on a display device a base reel game including a plurality of reels displaying at least one of: (i) a plurality of game symbols, or (ii) at least one bolt-on symbol associated with one of the plurality of game symbols, the bolt-on symbols associated with instructions stored in the at least one memory subsequent to instructions associated with the base reel game; determine that an outcome of the base reel game triggers a map game corresponding to the at least one bolt-on symbol displayed on one of the plurality of reels, the map game associated with the instructions stored in the at least one memory subsequent to instructions associated with the base reel game; cause to be displayed on the display device the map game including a plurality of map spaces, each of the plurality of map spaces associated with one of a plurality of bonus games or a prize value; define a map game outcome including one map space of the plurality of map spaces of the map game; and in response to defining the map game outcome, cause to be displayed on the display device one of the plurality of bonus games or the prize value associated with the map space of the plurality of map spaces included in the defined map game outcome.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is an example user interface or screenshot of a base reel game for an example electronic game in accordance with the present disclosure.

FIGS. 5A and 5B are example user interfaces or screenshots of a sequence of gameplay of the base reel game of FIG. 4, in accordance with the present disclosure.

FIG. 5C is an enlarged portion of an example interface or screenshot of the base reel game of FIG. 5B, in accordance with the present disclosure.

FIG. 5D is an example user interface or screenshot of gameplay of the base reel game of FIG. 4 including the triggering of a bonus map game, in accordance with the present disclosure.

FIG. 5E is an enlarged portion of an example interface or screenshot of the base reel game of FIG. 5D, in accordance with the present disclosure.

FIG. 5F is an example user interface or screenshot of gameplay of the base reel game of FIG. 4 including a bonus map game notification, in accordance with the present disclosure.

FIGS. 6A-6C are example user interfaces or screenshots of a sequence of gameplay of a bonus map game triggered within a base reel game, in accordance with the present disclosure.

FIG. 6D is an example user interface or screenshot of gameplay of the bonus map game of FIGS. 6A-6C including an awarded credit prize bonus, in accordance with the present disclosure.

FIG. 6E is an example user interface or screenshot of gameplay of a base reel game after the bonus map game of FIGS. 6A-6D ends, in accordance with the present disclosure.

FIGS. 7A and 7B are example user interfaces or screenshots of a sequence of gameplay of a bonus wheel game triggered within a bonus map game, in accordance with the present disclosure.

FIGS. 8A-8D are example user interfaces or screenshots of a sequence of gameplay of a pick bonus game triggered within a bonus map game, in accordance with the present disclosure.

FIGS. 9A-9G are example user interfaces or screenshots of a sequence of gameplay of a free spin bonus game triggered within a bonus map game, in accordance with the present disclosure.

FIGS. 10A-10F are example user interfaces or screenshots of a sequence of gameplay of a hold-and-spin bonus game triggered within a bonus map game, in accordance with the present disclosure.

FIGS. 11A and 11B are example user interfaces or screenshots of a sequence of gameplay of a bonus map game after reaching an end map space within the bonus map game, in accordance with the present disclosure.

FIG. 11C is an example user interface or screen shot of a base reel game displaying a notification subsequent to reaching the end map space within the bonus map game of FIGS. 11A and 11B, in accordance with the present disclosure.

FIG. 11D is an enlarged portion of an example interface or screenshot of the base reel game of FIG. 11C, in accordance with the present disclosure.

FIGS. 12 and 13 are example user interfaces or screenshots of a bonus map game after reaching an end map space within the bonus map game, in accordance with the present disclosure.

FIGS. 14A-14C are example user interfaces or screenshots of a base reel game displaying locked and unlocked maps for a bonus map game, in accordance with the present disclosure.

FIGS. 15A-16B illustrate example screenshots and/or interfaces of an electronic game including base reel games and bonus map games, in accordance with the present disclosure.

### DETAILED DESCRIPTION

In some known electronic gaming systems, awards and/or outcomes of a primary game may present a game outcome as a reel game (e.g., a slot game) simulation. For example, an award value associated with a game outcome may be presented in the simulated reel game outcome as a symbol combination and/or one or more special symbols that correspond to the same award value. Additionally in some known games, the award value of the game outcome may desirably be partitioned or distributed across a base reel game outcome and one or more bonus game outcomes (e.g., outcomes of one or more free reel spins, wheel spins, or hold-and-spin). For example, an award value associated with one or more winning bingo patterns may be presented as being awarded in a base reel game outcome and one or more bonus game outcomes. However, not all known electronic games include secondary bonus games due to the difficulty and complexity of increased mathematical computations and/or winning probability scenarios (e.g., pay tables) that must be determined and established to meet ethical gaming standards. For example, when a single secondary bonus game is implemented in a base game, new pay tables must be created for both the base game and the bonus game in order to comply with ethical gaming standards. While some variations exist for presenting the game outcomes across the base reel game outcome and/or the one or more bonus game outcomes exist, the difficulty in creating numerous pay tables across the base reel game and bonus games increase the calculation complexities exponentially when compared to just a single, base reel game. A need exists to address these limitations, while also improving on machine performance, memory storage and the overall functioning of the networked system controlling the gaming devices.

Embodiments of the present disclosure provide systems, program products, and methods for including bolt-on symbols added to game symbols of an existing game to incorporate a distinct, bonus map game within the existing game. The bonus map games described herein also include pick bonus games, hold-and-spin games, free spin bonus games, and bonus wheel games, respectively. By including bolt-on symbols that are associated with and displayed with gaming symbols of an existing game, players of the existing game may be provided an entirely new, bonus map game to play within or in conjunction with the base reel game. These bolt-on symbols trigger the bonus map game when trigger conditions are met (e.g., number of instances the bolt-on symbol appears during the base reel game). Additionally, and because the bonus map game is independent from the base reel game, does not rely on game symbols for determining outcomes of the base reel game, and/or only is triggered based on the displaying of the bolt-on symbols during the base reel game, mathematical computations and/or winning probability scenarios (e.g., pay tables) for the base reel game may remain the same after implementing the bolt-on symbols and bonus map games. As such, existing games are capable of being “upgraded” to include the distinct bonus map game without reworking existing pay tables and/or the need to create an increased number and/or increasingly complex pay table to be used across both the base reel game and the bonus map game.

The inclusion of the bolt-on symbols in an existing game to trigger a bonus map game potentially increases the variability of the game including the various bonus games, as well as improve control and assurance of RTP during the gameplay. For example, the bolt-on symbols and the frequency in which they are displayed or included within the outcome of the base reel game is determined independent from the outcome of the base reel game itself (e.g., game symbols included in the base reel game). The triggering of the bonus map games independent of the base reel game eliminates the need and/or requirement of reworking existing pay tables and/or creating increased complexities in pay tables for the base reel game when implementing the bonus map game in the existing base reel game.

The example systems, program products, and methods of the present disclosure represent a technical improvement in the field of electronic gaming. Technical improvements represented by the present disclosure include: (i) presenting Class II and Class III game outcomes as one or more outcomes of a bonus map game added within an existing game; (ii) utilizing multiple map bonus games to provide additional gameplay features/winning opportunities during the gameplay of a previously existing game; (iii) increasing the flexibility and variability in presenting award values of a game outcome as one or more bonus map game outcomes; (iv) displaying immediate bonus game feedback to a player; and/or (v) improved control and assurance of RTP by enabling control of the credit awards through the bonus map game added to the existing reel game. Additional and/or alternative technical improvements may exist.

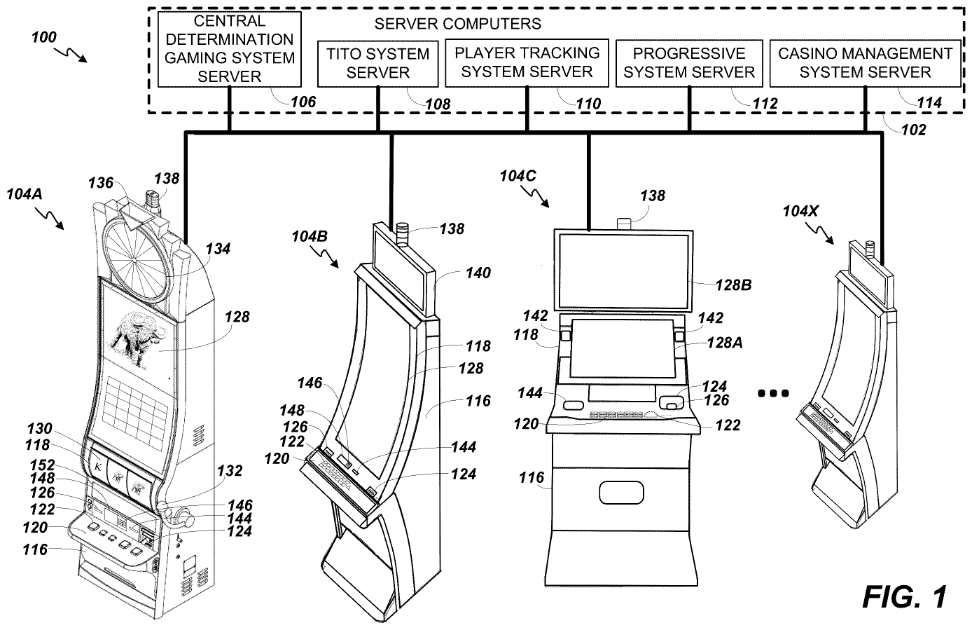

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

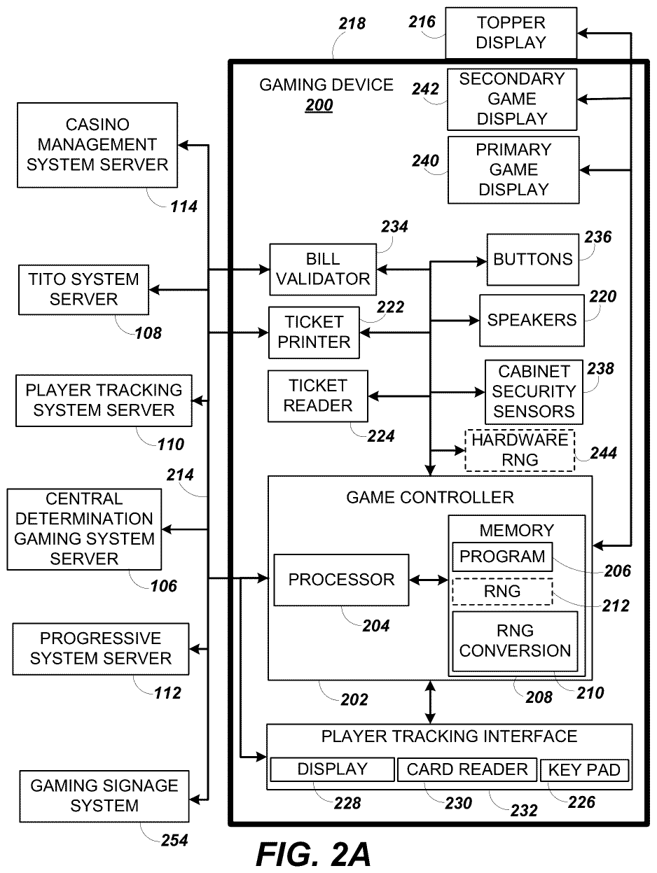

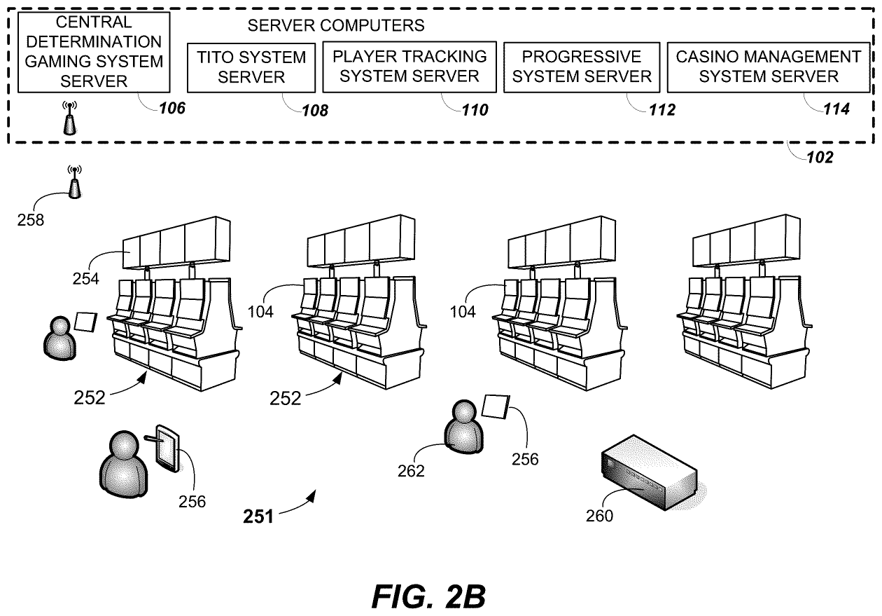

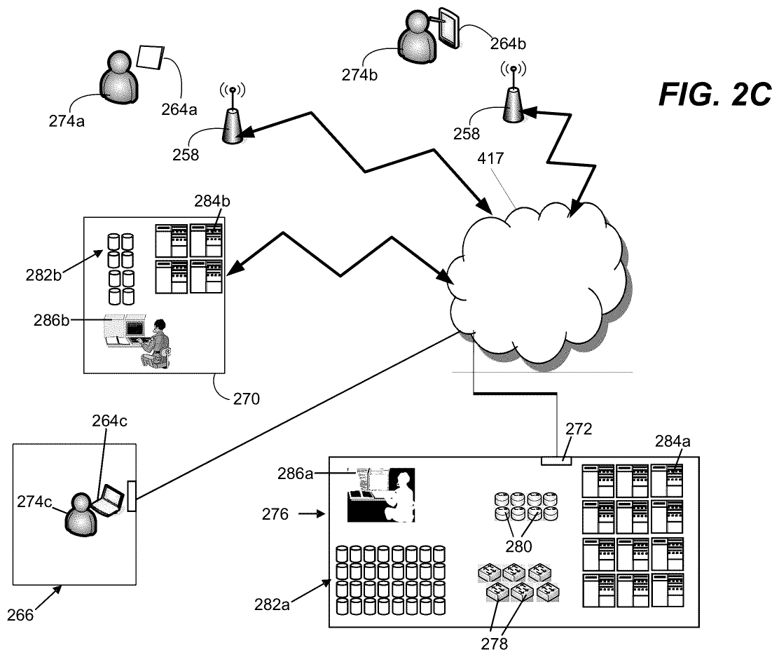

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play, or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2A also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more Uis, the game outcome on one or more of the primary game displays 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding number of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

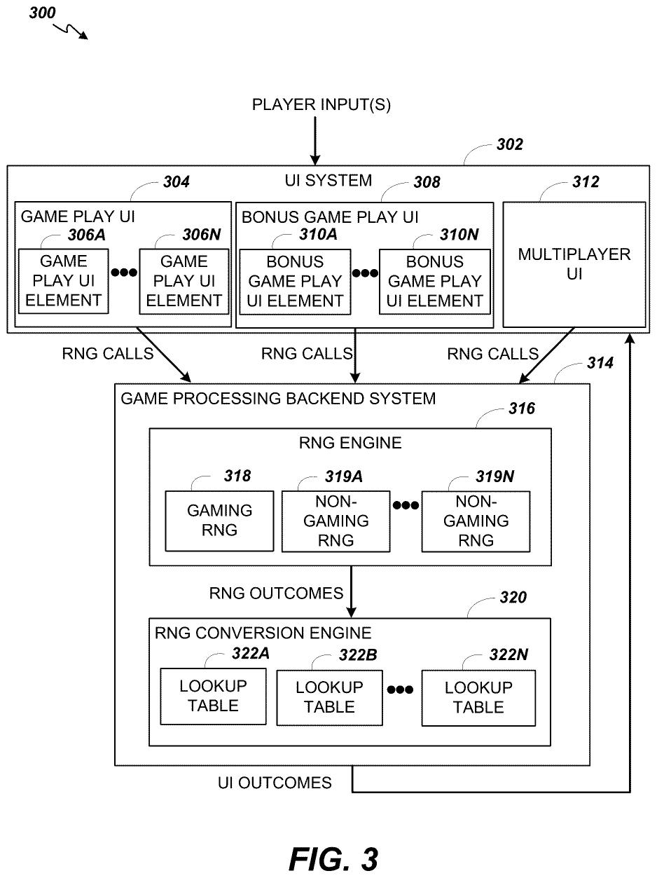

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more Uis that a player can interact with. The UI system 302 could include one or more game play Uis 304, one or more bonus game play Uis 308, and one or more multiplayer Uis 312, where each UI type includes one or more mechanical Uis and/or graphical Uis (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

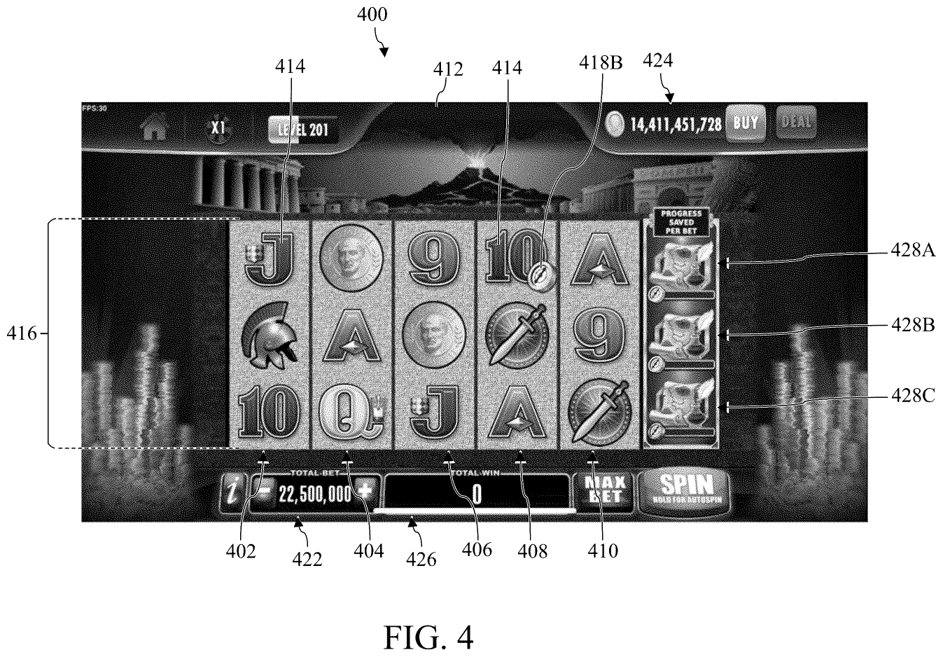

FIG. 4 is an example user interface or screenshot of an example base reel game 400 played on a gaming device (e.g., gaming devices 104A-104X in FIG. 1, and/or gaming device 200 and/or mobile gaming device 256 in FIG. 2B). Specifically, FIG. 4 shows a base reel game 400, in which a base reel game outcome is displayed that corresponds to (e.g., presents, represents, and/or is determined from) an output of the gaming device. The output may be a primary or base reel game outcome determined in response to a wager received from a player. In example implementations, the primary game outcome is a Class II (e.g., bingo) game outcome or a Class III or Las-Vegas style game outcome. In various implementations, the base reel game 400 may be implemented to present an outcome of any suitable game of chance. Specific details of the type of primary or base reel game outcomes presented using the base reel game 400 are not central to an understanding of the present disclosure. However, additional detail related to at least one implementation (e.g., an implementation employing the base reel game 400 to present a primary bingo-based or Class II game outcome) may be obtained with reference to U.S. Published Patent Application No. 2012/0270638, filed Apr. 20, 2011, and entitled GAMING MACHINE WITH FREE PLAY BONUS MODE PRESENTING ONLY WINNING OUTCOMES, the disclosure of which is hereby incorporated by reference herein in its entirety.

The base reel game 400 may be initiated on a gaming device 104A-104X, 200 and/or mobile gaming device 256. For example, a player may fund the base reel game 400 via bill validator 234 and/or ticket reader 224. Once funded, the base reel game 400, which includes a first plurality of reels 402, 404, 406, 408, and/or 410, each including a plurality of game symbols 414 that appear on a display device 412. The first plurality of reels 402-410 may be physical reels and/or virtual reels. As used herein, physical reels are mechanical in nature and may be physically rotated during gameplay. In contrast, virtual reels are rendered or visually created by game controller 202 on a display, such as primary game display 240, and are merely animated to give the appearance of being spun. The first plurality of reels 402-410 of the example base reel game 400 includes five reels. In other examples, the number of reels may range from one reel to five or more reels in number. The base reel game 400 may be played on display device 412. However, in other implementations, the base reel game 400 may be played on several displays including display device 412 and one or more additional or auxiliary displays.

The base reel game 400 may be played on multiple displays, such as the primary display device 412 and a secondary display. However, in other implementations, the base reel game 400 may be played on a single display and/or on greater than two displays. Additionally, display device 412 can be configured as a touch enabled display device to allow the player to engage with and/or play base reel game 400 and/or interactive pick bonus game, when displayed on touch enabled display device 412. For example, where the gaming device is formed as mobile gaming device 256 (see, FIG. 2B), display device 412 includes mobile gaming device's 256 touch screen or screens. As discussed herein, the user or player may touch display device 412 to operate and/or interact with base reel game 400 and/or interactive pick bonus game during game play. Touch enabled display device 412 (and/or controller 202/processor 204) may detect, recognize, and/or identify the player's touch, and determine the player's various interactions and/or selections during gameplay.

In the example shown in FIG. 4, the base reel game 400 includes a first reel matrix on the primary display device 412. The first reel matrix includes a plurality of symbol arrangements or positions arranged in a plurality of rows and a plurality of columns. The first reel matrix may also therefore be referred to as a “matrix of symbol positions” or “matrix of symbol arrangements.” While, in the example shown in FIG. 4, the first reel matrix is displayed on the primary display device 412, the first reel matrix may appear in other locations on an EGM 104A-104X and/or on other displays, such as, for example, the secondary display, a display of button deck 120, and the like. In the example embodiment shown in FIG. 4, the plurality of reels 402-410 form five distinct reels and/or five columns. Each reel 402-410 also includes a number of rows as well. In the exemplary embodiment, reels 402-410 have three (3) rows. As a result, the plurality of reels 402-410 for base reel game 400 include a 3×3×3×3×3 arrangement, as depicted on display device 412, and include fifteen (15) game symbol positions.

In other implementations, the plurality of reels 402-410 may be any size/uniformity/arrangement (e.g., 2×2, 3×3, 4×4, 10×10, etc.), and a number of game symbol positions for the plurality of reels 402-410 may vary depending upon a number of rows and columns of the plurality of reels 402-410. In some implementations, the plurality of reels 402-410 may be replaced by one or more mechanical reels, and the implementations described herein work equally well with mechanical reels as with the virtual plurality of reels 402-410, as shown in FIG. 4. Each row of the plurality of reels 402-410 may be designated by a row number (e.g., “1,” “2,” “3,” etc.). Each column of the plurality of reels 402-410 may be designated by a column letter (e.g., “A,” “B,” “C,” “D,” “E,” etc.). Each game symbol position of the plurality of reels 402-410 may therefore be designated by a symbol position identifier comprising a row number (e.g., “1,” “2,” “3,” etc.) and a column letter (e.g., “A,” “B,” “C,” “D,” “E,” etc.). For example, the upper-right-most game symbol position, occurring at the intersection of row 1 and column E, may be designated by the game symbol position identifier “1E.” In another example, the bottom most game symbol position for reel 406, occurring at the intersection of row 3 and column C, may be designated by the game symbol position identifier “3C.”

As described herein, during play of the base reel game 400, game symbols 414 may be selected (e.g., such as from the plurality of reels 402-410) and displayed in the game symbol positions of each column and row of the plurality of reels 402-410. Although not central to an understanding of the present disclosure, each of the plurality of reels 402-410 may include a plurality of game symbols 414 arranged in a vertical column. A number of game symbols 414 of each reel 402-410, corresponding to the number of rows of the plurality of reels 402-410, is displayed in a column of game symbol positions within the plurality of reels 402-410 during play of the base reel game 400. To display symbols from a reel within the plurality of reels 402-410, processor 204 may simulate rotation or spinning of one or more of the plurality of reels 402-410 within a respective column of the plurality of reels 402-410. Here again, however, mechanical reels having physical reel strips may be used as well. When a respective reel is simulated to halt or stop within an associated column, one or more game symbols 414 may be displayed from the reel 402-410 in the game symbol positions of the column. The game symbols 414 displayed after spinning and stopping each reel strip in a respective column of the plurality of reels 402-410 may be referred to herein as a “reel outcome” or a “base reel game outcome” or a “base game outcome.” More broadly, an “outcome” of a reel game, such as a base reel game (e.g., the base reel game 400) refers to the game symbols 414 displayed in the plurality of reels 402-410 after reel strips are spun and stopped. Thus, a rotation and stopping of a plurality of reel strips (also referred to herein as a “spin and stop sequence”) may be simulated by processor 204 within the columns of the plurality of reels 402-410 to cause a reel outcome, including a plurality of game symbols 414, to be displayed from the plurality of reel strips within the columns of the plurality of reels 402-410.

As shown in the exemplary embodiment of FIG. 4, and as discussed herein, the plurality of game symbols 414 included and/or displayed within the plurality of reels 402-410 include and/or are formed from various symbol types. For example, graphic game symbols of the plurality of game symbols 414 include predetermined graphics, symbols, and/or art works that can be based on a theme, story, and/or visual representation of base reel game 400. Additionally, or alternatively, graphic game symbols include suitable graphics, symbols, and/or artworks commonly associated with gaming device (e.g., “BAR,” “SPIN,” “WILD,” etc.). Collectively, these game symbols 414 are referred to herein as graphic symbols 416. Additionally, the plurality of game symbols 414 can include cash-on-reel (COR) symbols (not shown) displayed within the plurality of reels 402-410. COR symbols include, display, depict, and/or are associated with a predetermined credit value (e.g., COR credit value) that can provide additional award credits to the player during base reel game 400. The plurality of game symbols 414 can also include jackpot symbols (not shown), which include, display, depict, and/or are associated with jackpots, as discussed herein. That is, jackpot symbols can provide additional award credits to the player during base reel game 400.

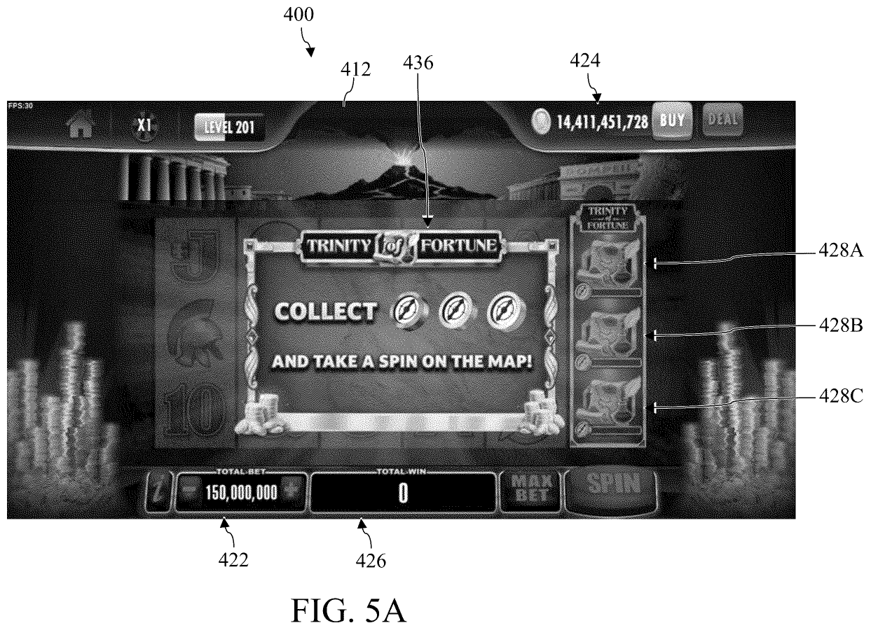

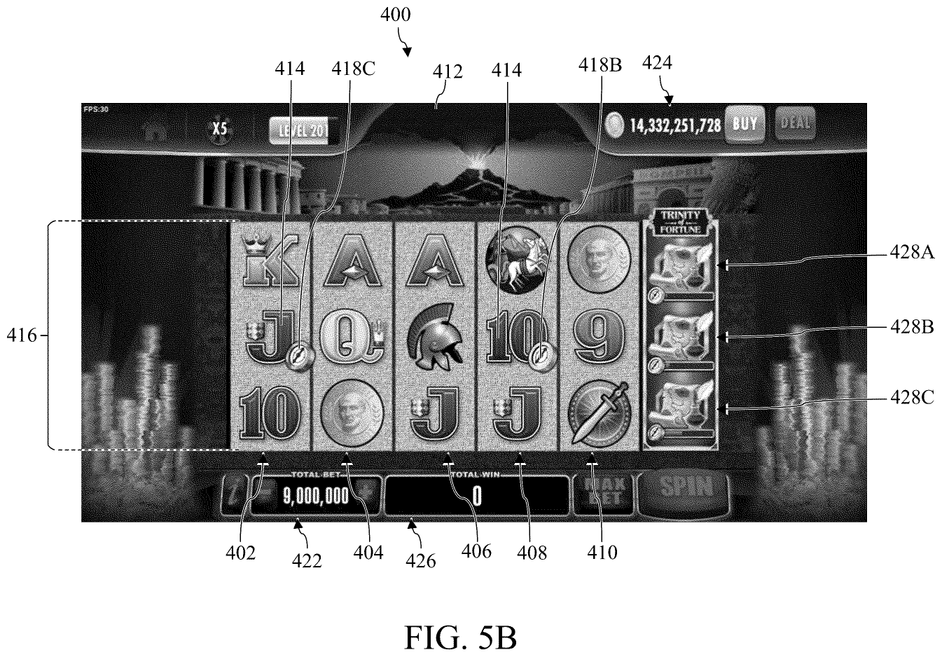

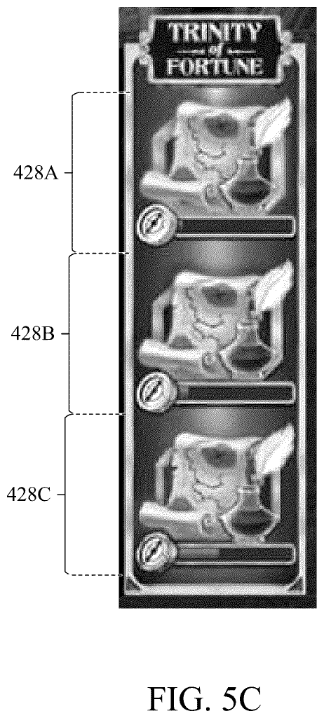

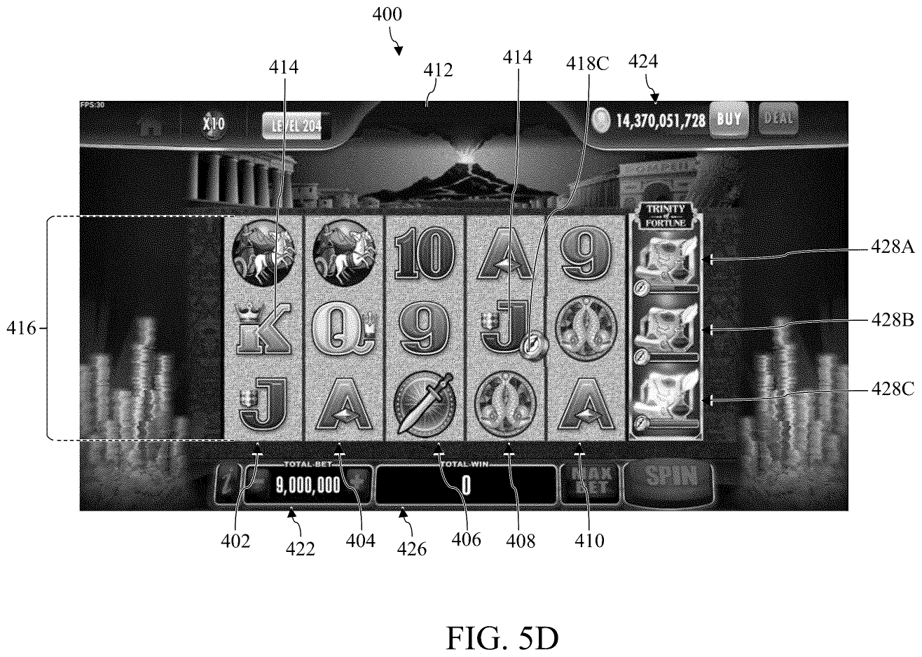

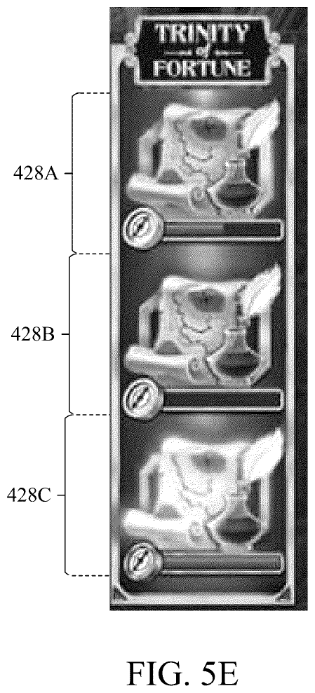

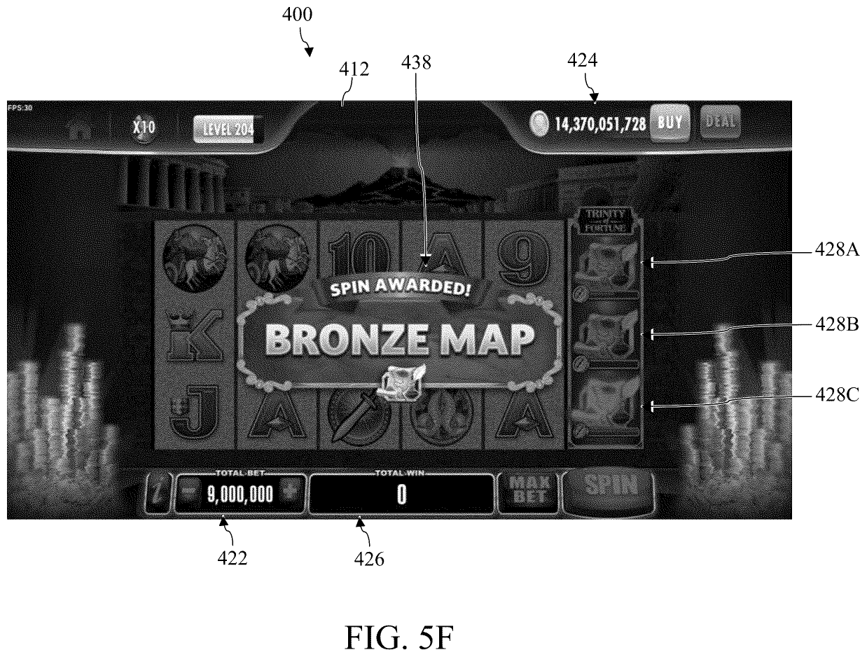

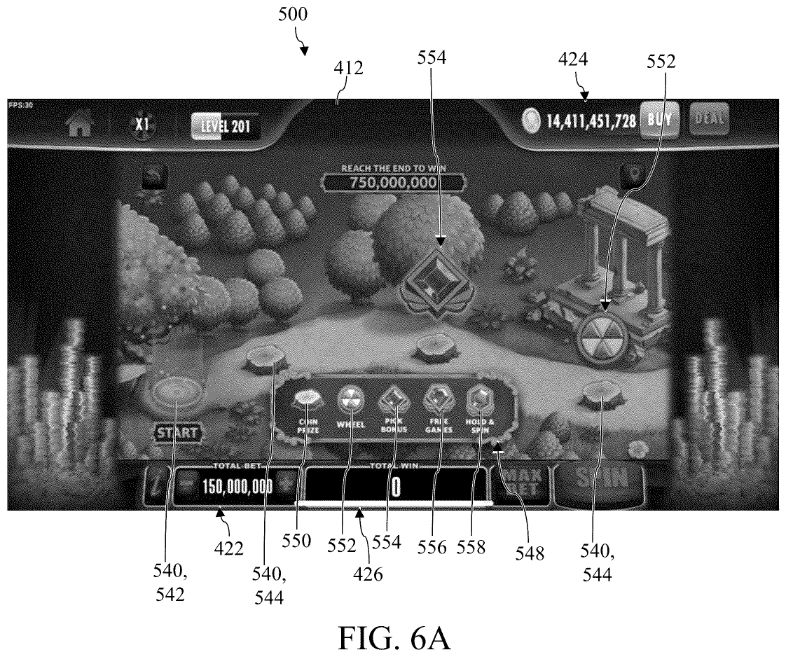

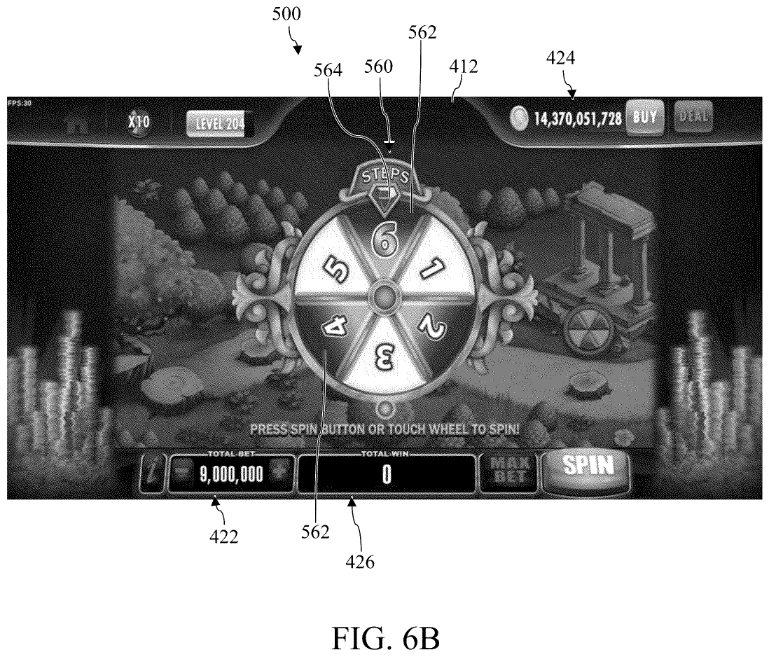

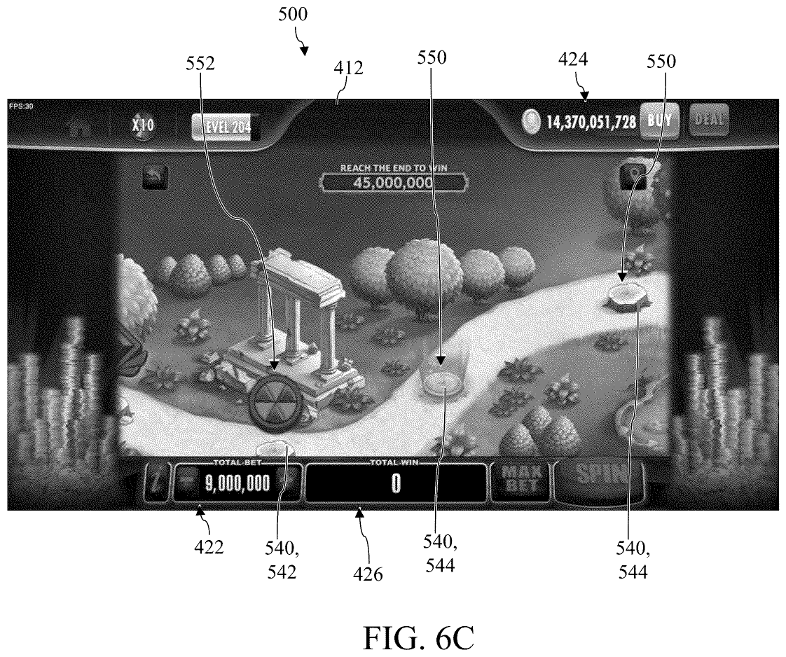

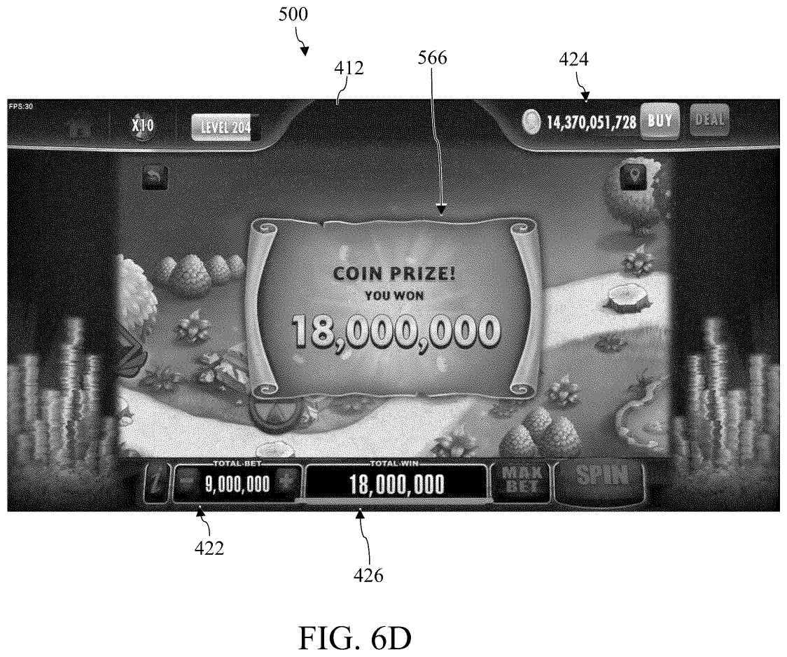

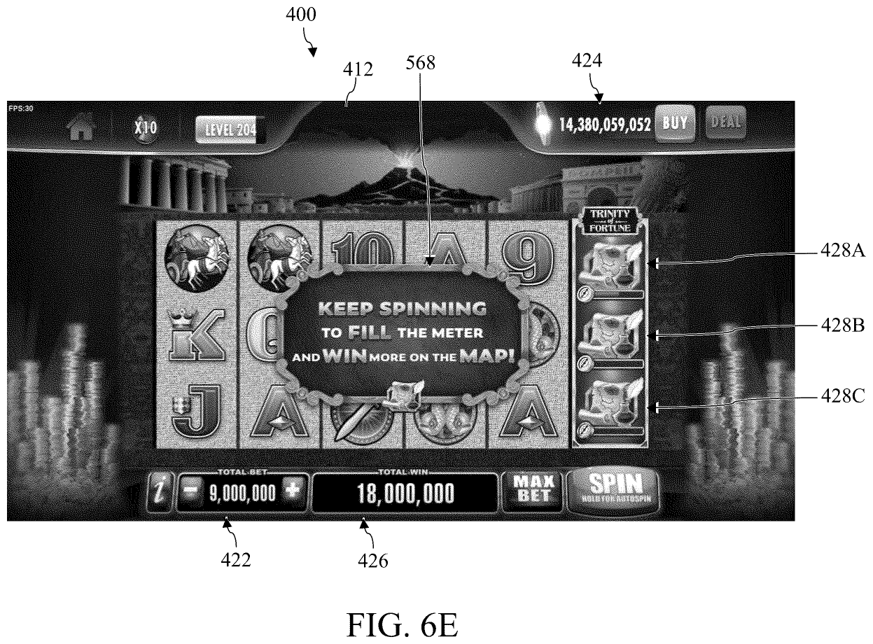

Base reel game 400 also displays bolt-on symbol 418 associated with game symbols 414. More specifically, bolt-on symbol 418 are associated with some of the plurality of game symbols 414 and/or are occasionally displayed with game symbols 414 in the outcomes of base reel game 400—but not always. Bolt-on symbols 418 are included and/or displayed within the plurality of reels 402-410 adjacent to (e.g., subscript position) the corresponding game symbol 414. As shown in FIG. 4 bolt-on symbol 418 is associated with and displayed over and/or directly adjacent game symbol 414 depicted in the number “10.” Additionally, and similar to game symbols 414, bolt-on symbols 418 are formed as graphic game symbols including predetermined graphics, symbols, and/or art works that can be based on a theme, story, and/or visual representation of base reel game 400. In the non-limiting examples discussed herein, bolt-on symbols 418 are displayed as different color compasses, where each uniquely colored compass corresponds to a distinct bonus map game 500 (see e.g., FIGS. 5F and 6A). In exemplary embodiments, bolt-on symbols 418 can trigger, enable, and/or activate bonus map games 500, as discussed herein. For example, and as discussed herein, where a predetermined number of bolt-on symbols 418 are displayed in the base reel game outcome, bonus map game 500 is activated on display device 412 (see, FIG. 6A). As discussed herein, bolt-on symbols 418 are added to existing games (e.g., base reel game 400) and enhances base reel game 400 by now incorporating bonus map game 500 during game play.

Base reel game 400 also includes a wager meter 422, and a credit meter 424 depicted on display device 412. Wager meter 422 represents and/or displays the credit and/or monetary value being wagered during each play of base reel game 400, as determined by the player. Credit meter 424 displays a credit balance (calculated as a sum total of credits input and awards accrued minus wagers placed) accrued until a player cashes out. As shown in FIG. 4, a win meter 426 is also displayed in base reel game 400. As discussed herein, win meter 426 displays a credit and/or monetary value awarded during outcomes of the base reel game 400, or during a bonus map game 500 (see, FIGS. 6A-6E), as discussed herein.

Base reel game 400 also displays a map game progress indicator or meter 428 (hereafter, “progress indicator 428”). In exemplary embodiments, base reel game 400 depicts three progress indicators 428A, 428B, 428C -each associated with a distinct map for bonus map game 500. That is, and as discussed herein, progress indicator 428A is associated with and/or corresponds to a “gold map” for bonus map game 500, progress indicator 428B is associated with and/or corresponds to a “silver map,” and progress indicator 428C is associated with and/or corresponds to a “bronze map.” Progress indicators 428A, 428B, 428C provides a visual representation and/or illustration indicating how close a player is to triggering a corresponding bonus map game 500. More specifically, progress indicators 428A, 428B, 428C include a visual graphic displayed on display device 412 to dynamically indicate and/or represent to a player of base reel game 400 whether or not they are likely to trigger the bonus map game 500, as discussed herein. In exemplary embodiments shown in FIG. 4, progress indicators 428A, 428B, 428C includes a movable, metamorphic, animated, and/or fillable bar. As more triggering outcomes occur during base reel game 400 (e.g., displaying of bolt-on symbols 418), the bar of progress indicators 428A, 428B, 428C move from left to right to represent that a player is getting closer to triggering bonus map game 500. In the exemplary embodiment shown in FIG. 4, each bar is in a left-most position of progress indicator 428A, 428B, 428C. As such, progress indicators 428A, 428B, 428C displayed in base reel game 400 indicate to the player that bonus map game 500 has not been triggered. Although discussed herein including a fillable bar, it is to be understood that progress indicators 428A, 428B, 428C can be formed and/or displayed as any suitable visual indicator including, but not limited to, a needle-gauge, animated letters (e.g., “BONUS”), or a metamorphic animation.

During operation, the reel outcome presented during play of the base reel game 400 (e.g., base reel game outcome) corresponds to, presents, represents, and/or is determined from a primary game outcome. For example, the reel outcome (base reel game outcome) may correspond to a primary or underlying Class II game, or the reel outcome may be determined randomly (e.g., in Class III games). Additionally, and as discussed herein, base reel game outcomes and/or conditions of base reel game 400 can trigger bonus map game 500 (see, FIG. 6A) and in turn the bonus games and/or prize values included in bonus map game 500 (see e.g., FIGS. 6D, 7B, and 8B). For example, and as discussed herein, displaying a predetermined number of bolt-on symbols 418 over the course of multiple base reel game outcome can trigger bonus map game 500 on display device 412.

Each of the plurality of reels 402-410, as well as graphic game symbols 416 and/or the plurality of game symbols 414, are all defined in at least one reel stop position table. In exemplary embodiments, the reel stop position table(s) defines each reel of the plurality of reels 402-410 used in base reel game 400, the number of reel stop positions in each reel 402-410, the reel stop position of each of the plurality of graphic game symbols 416/game symbols 414 within each reel 402-410, and the like. The reel stop position table(s) defining the plurality of reels 402-410 for base reel game 400 are stored in RNG conversion engine 320 (see, FIG. 3). As discussed herein, RNG engine 316 is communicatively coupled to and/or capable of communicating with the reel stop position table(s) stored within RNG conversion engine 320. During gameplay of base reel game 400, RNG engine 316 of game processing architecture 300 pulls and/or generates a random reel position number for each of the plurality of reels 402-410 (e.g., five (5) distinct RNGs) when initiating or playing base reel game 400 in order to determine a base reel game outcome.

Each of the bolt-on symbols 418 included in base reel game 400 are defined in at least one distinct stop position table that defines a stop position of each of the plurality of bolt-on symbols 418 within each reel 402-410. That is, the distinct stop position table defines the bolt-on symbols 418 and a stop position corresponding to and/or associated with one of the plurality of reels 402-410 included in base reel game 400. Within the distinct stop position table, not all stop positions include a bolt-on symbol 418. For example, and with respect to reel 402, an individual bolt-on symbol 418 (e.g., bronze compass, silver compass, etc.) may be present, included in, and/or associated with stop positions #10, #12, and #18, respectively. The remaining stop positions (e.g., stop positions #1-9, #11, #13-17, etc.) do not include bolt-on symbols 418 and/or are “blank” or empty. Similar to the reel stop position table(s) defining the plurality of reels 402-410 for base reel game 400, the distinct stop position table defining the stop position for each of the plurality of bolt-on symbols 418 is stored in RNG conversion engine 320 (see, FIG. 3).

As discussed herein, RNG engine 316 is communicatively coupled to and/or capable of communicating with both the reel stop position table(s) stored within RNG conversion engine 320, and the distinct, stop position table independent one another. In an exemplary embodiment, and during gameplay of base reel game 400, RNG engine 316 of game processing architecture 300 pulls and/or generates a random reel position number for each of the plurality of reels 402-410 (e.g., five (5) distinct RNGs) when initiating or playing base reel game 400 in order to determine a base reel game outcome. Additionally, and separate from the generated random reel position number for each of the plurality of reels 402-410, RNG engine 316 of game processing architecture 300 also pulls and/or generates a random reel position number for each of the plurality of bolt-on symbols 418 (e.g., five (5) distinct RNGs) when initiating or playing base reel game 400 in order to determine whether the base reel game outcome includes bolt-on symbols 418 displayed on reels 402-410. As a result of having two distinct position tables for graphic game symbols 416/game symbols 414 within each reel 402-410 and bolt-on symbols 418 overlaying game symbols 414, triggering events relating to bolt-on symbols 418 (e.g., bonus games) are independent and/or separate from base reel game outcomes determined by graphic game symbols 416/game symbols 414 within each reel 402-410. This in turn improves control and/or assurances of RTP during base reel game 400 and/or bonus map game 500, as discussed herein.

FIGS. 5A-5F are example user interfaces or screenshots of an example gameplay of base reel game 400 played on a gaming device (e.g., gaming devices 104A-104X in FIG. 1, and/or gaming device 200 and/or mobile gaming device 256 in FIG. 2B). Specifically, FIG. 5A is a notification 436 provided on display 412 prior to playing base reel game 400, while FIG. 5B shows a base reel game outcome for base reel game 400, in which a base reel game outcome is displayed that corresponds to (e.g., presents, represents, and/or is determined from) an output of the gaming device. FIG. 5C shows an enlarged view of map game progress indicators 428A, 428B, 428C displayed during base reel game 400, FIG. 5D shows a subsequent base reel game outcome for base reel game 400, FIG. 5E shows an enlarged view of map game progress indicators 428A, 428B, 428C displayed in base reel game outcome of base reel game 400 shown in FIG. 5D, and FIG. 5F is a bonus map game notification 438 displayed on display 412 triggered as a result of base reel game outcome of base reel game 400 triggering bonus map game 500.

Turning to FIG. 5A, a user interface or screen shot displaying a notification 436 prior to playing base reel game 400 is shown. In the exemplary embodiment, notification 436 provides instructions to the user or player regarding bonus map game 500. More specifically, and where bolt-on symbols 418 and corresponding bonus map game 500 are incorporated into base reel game 400 after an initial launch base reel game, notification 436 is provided to the player and displayed on display device 412 prior to the player playing or engaging base reel game 400. Notification 436 indicates and/or provides instructions to the user or player that a secondary objective of base reel game 400 is to collected bolt-on symbols 418 (e.g., compasses) to trigger bonus map game 500 (e.g., “COLLECT [compasses] AND TAKE A SPIN ON THE MAP!”).

Turning to FIG. 5B, a user interface or screen shot displaying a base reel game outcome of the base reel game 400 is shown. In the exemplary embodiment, the plurality of reels 402-410 include two bolt-on symbols 418B, 418C associated with gameplay symbols 414. Bolt-on symbol 418B (e.g., “silver compass”), associated with and displayed adjacent gameplay symbol 414 depicting “10,” corresponds to a “silver map” for bonus map game 500. Additionally, bolt-on symbol 418C (e.g., “bronze compass), associated with and displayed adjacent gameplay symbol 414 depicting “J,” corresponds to a “bronze map” for bonus map game 500. Bolt-on symbols 418 can also include or display a gold compass corresponding to a “gold map” for bonus map game 500.

FIG. 5C is an enlarged screenshot of progress indicators 428A, 428B, 428C displayed during base reel game 400. As discussed herein, progress indicators 428A, 428B, 428C show progression toward bonus map game 500. In exemplary embodiments, each time a corresponding or associated bolt-on symbol 418 is displayed within the base reel game outcome, progress indicators 428A, 428B, 428C grow. Specifically, and with reference to FIG. 5B, fillable bars included in progress indicators 428B, 428C grow or fill as a result of bolt-on symbols 418B, 418C being displayed in the base reel game outcome. Additionally, fillable bars included in progress indicator 428A remains the same after base reel game outcome as a result of bolt-on symbol 418A not being displayed in the base reel game outcome.

FIGS. 5D and 5E show user interfaces or screen shots displaying a subsequent base reel game outcome of the base reel game 400. In the exemplary embodiment, display 412 displays a distinct base reel game outcome for base reel game 400 generated after the previous base reel game outcome, as shown in FIGS. 5B and 5C. As shown in FIG. 5D, bolt-on symbol 418C (e.g., “bronze compass), associated with and displayed adjacent gameplay symbol 414 depicting “J,” is displayed in the subsequent base reel game outcome for base reel game 400. As similarly discussed herein, fillable bars included in progress indicator 428C grows or fills as a result of bolt-on symbol 418C being displayed in the subsequent base reel game outcome. Additionally, and with reference to FIGS. 5C and 5E, the displaying of bolt-on symbol 418C in subsequent base reel game 400 also results in the fillable bar of progress indicator 428C transitioning from being partially filled (see, FIG. 5C) to being completely filled (see, FIG. 5E). The fillable bar of progress indicator 428C can transition, be animated, metamorphosize, and/or “fill” to indicate and/or represent that bonus map game 500 has been triggered.

Additionally, and to provide further visual representation, bonus map game notification 438 is displayed on display device 412 to provide an indication that bonus map game 500 is triggered. In the exemplary embodiment shown in FIG. 5F, bonus map game notification 438 provides instructions to the player that a spin within the bronze map has been award (e.g., “SPIN AWARDED! BRONZE MAP”). Visual and/or auditory cues can be presented to the player to identify that bonus map game 500 has been triggered based on the outcome of base reel game 400 and/or the filling of progress indicator 428C. In exemplary embodiments, words, symbols, letters, animations, and/or other visual effects may be displayed in bonus map game notification 438 on display device 412, in addition to and/or alternative to the color overlay.

FIGS. 6A-6E are example user interfaces or screenshots of an example gameplay of bonus map game 500 played on a gaming device (e.g., gaming devices 104A-104X in FIG. 1, and/or gaming device 200 and/or mobile gaming device 256 in FIG. 2B). Bonus map game 500 shown in FIGS. 6A-6E corresponds to a bronze map associated with progress indicator 428C and triggered by the displaying of a predetermined number of bolt-on symbol 418C in at least one base reel game outcome for base reel game 400 (see, FIGS. 5E and 5F).

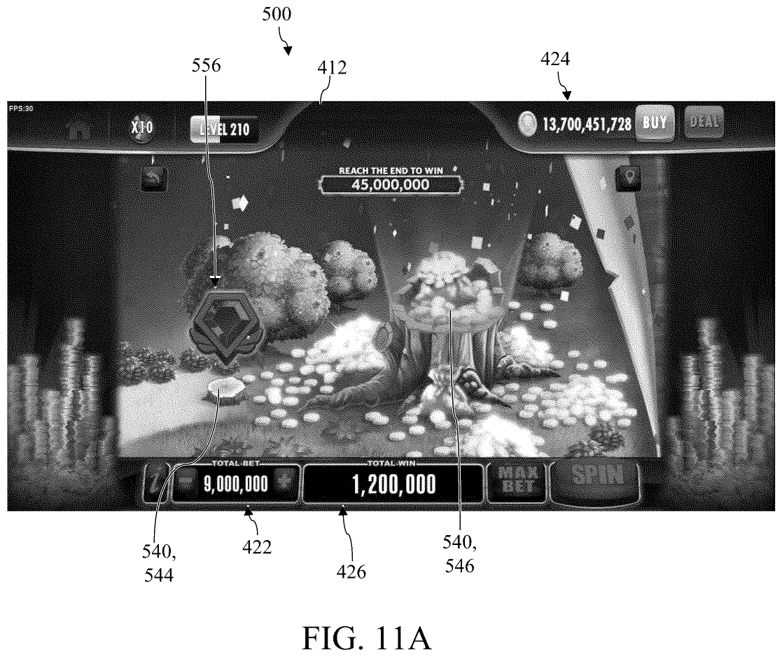

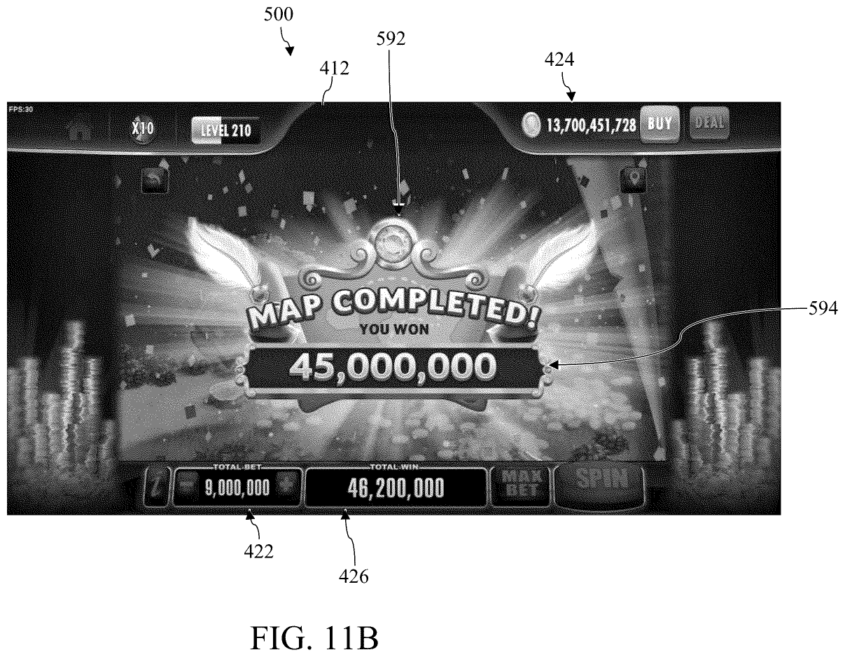

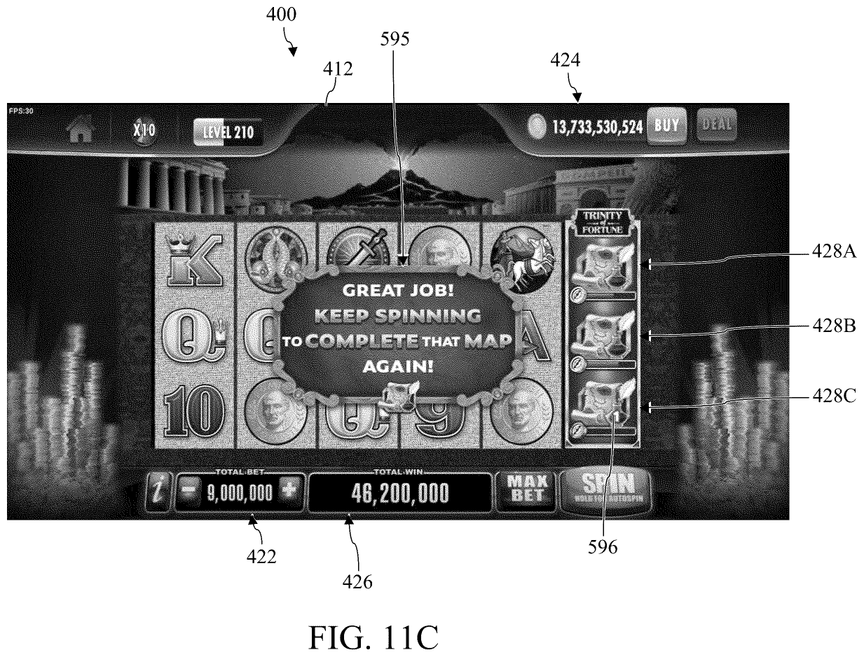

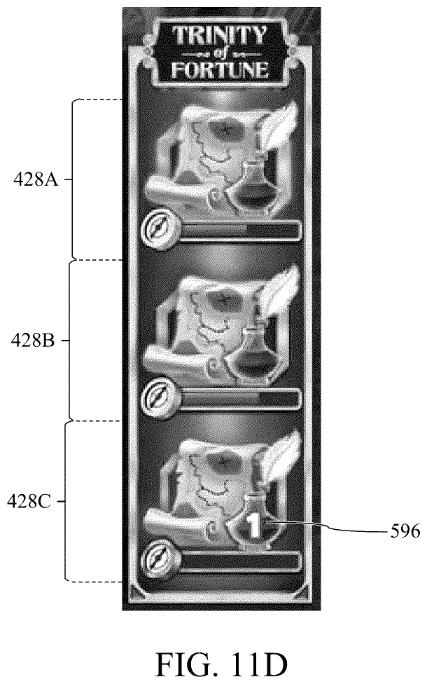

Turning to FIG. 6A, a user interface or screen shot displaying bonus map game 500 prior to a spin or bonus map game outcome is shown. Bonus map game 500 includes gameplay features including predetermined graphics, symbols, and/or art works that can be based on a theme, story, and/or visual representation similar to that of base reel game 400. In exemplary embodiments, gameplay features for bonus map game 500 include a plurality of distinct map spaces 540. More specifically, and as shown in FIG. 6A, prior to a bonus map game outcome being determined or generated, bonus map game 500 displays, depicts, and/or illustrates on display device 412 a plurality of distinct map spaces 540 including a starting map space 542, and a plurality of intermediate map spaces 544. Additionally, and as discussed herein, the plurality of distinct map spaces 540 include a final map space 546 (see, FIG. 11A). During the first play through of bonus map game 500, or alternatively after a player has previously reached the final map space 546 (see, FIGS. 11A-11D), the player starts at starting map space 542 within the map (e.g., bronze map). As discussed herein, each subsequent time bonus map game 500 is triggered after the initial turn, the players progress and determined bonus map game outcome (e.g., previously landed map space 544) is saved.

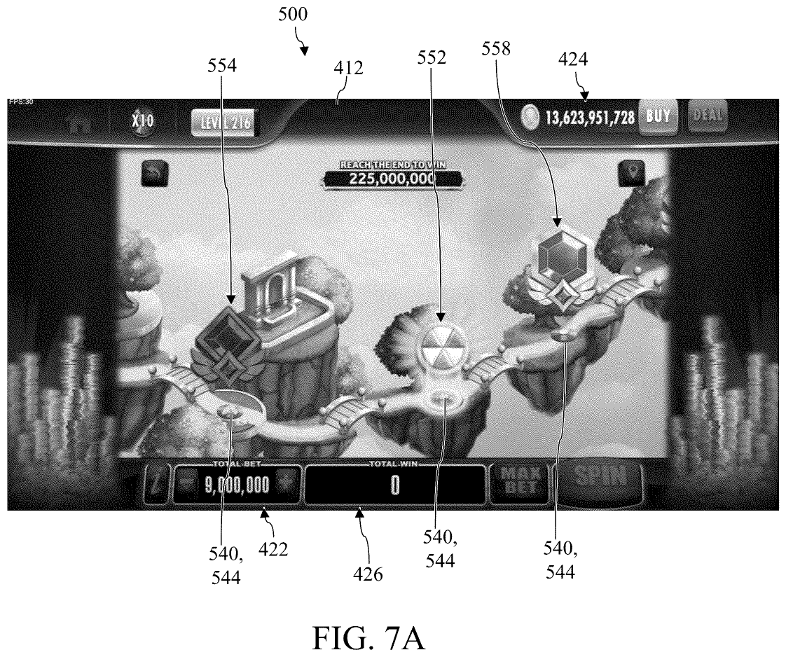

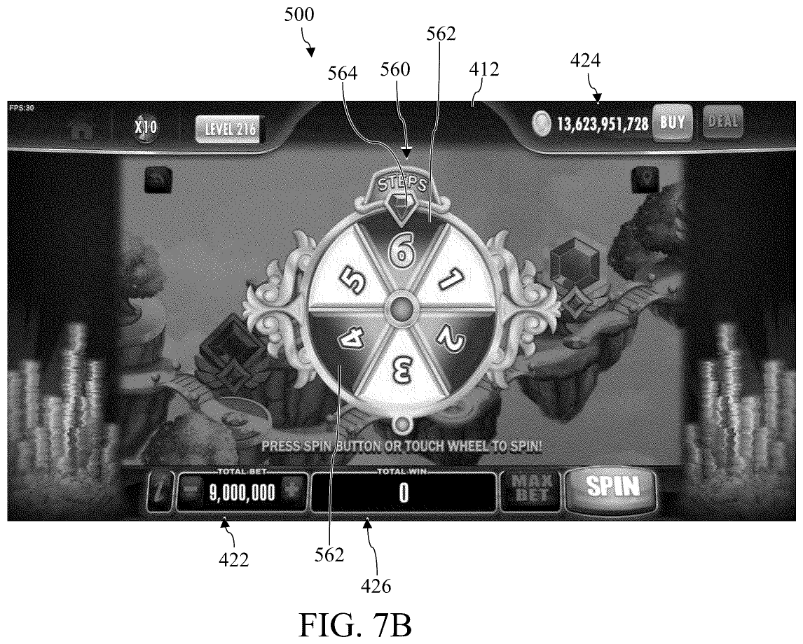

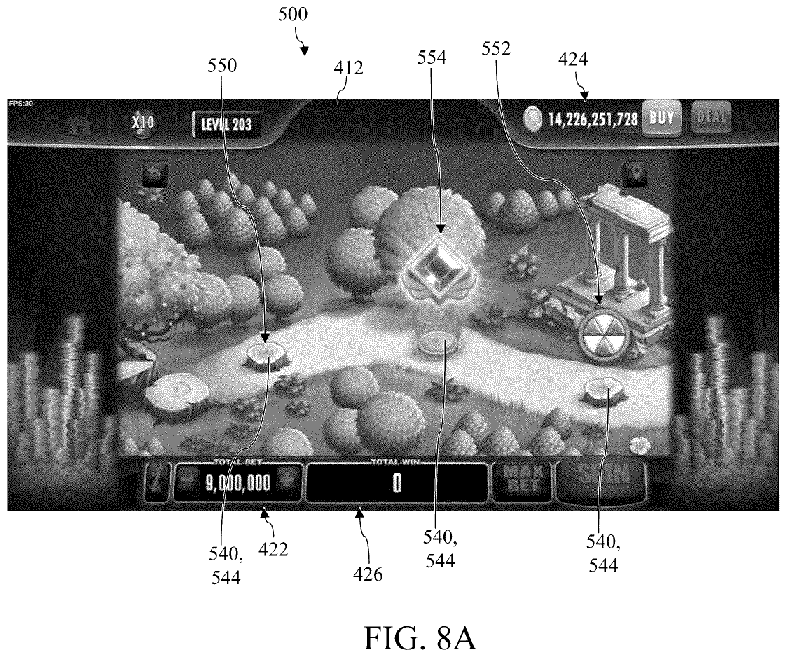

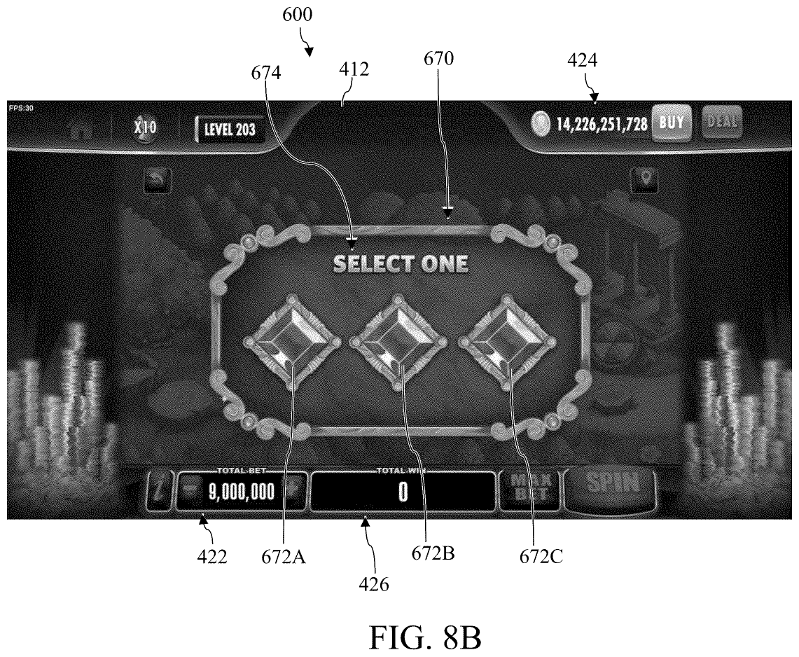

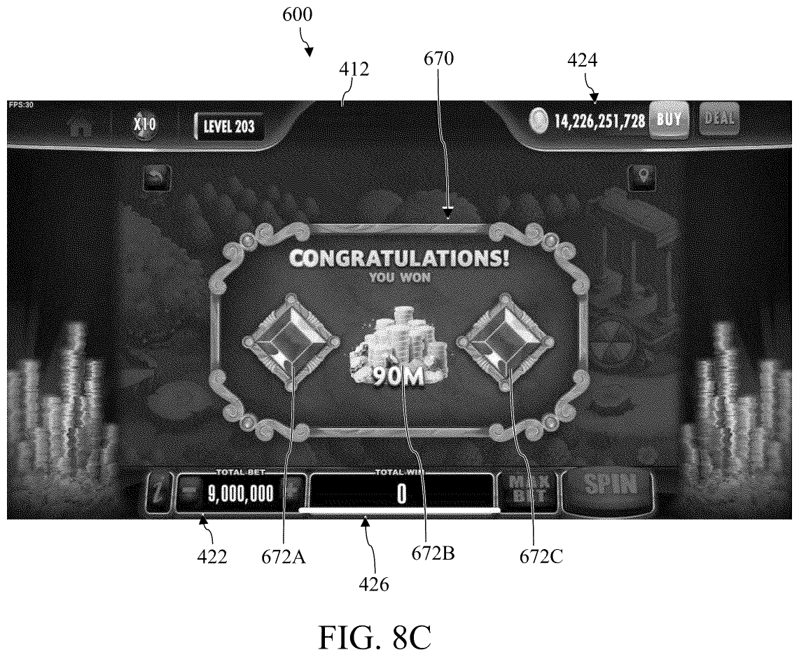

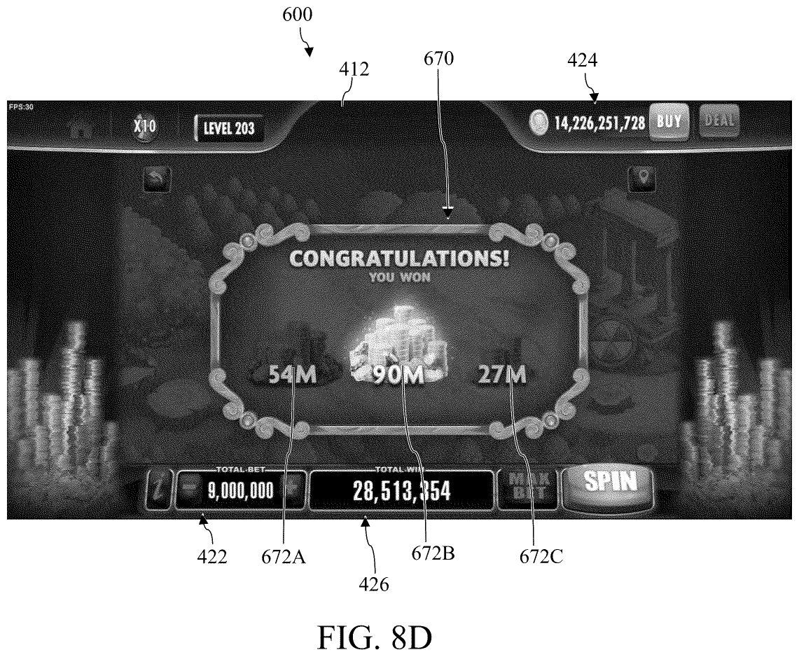

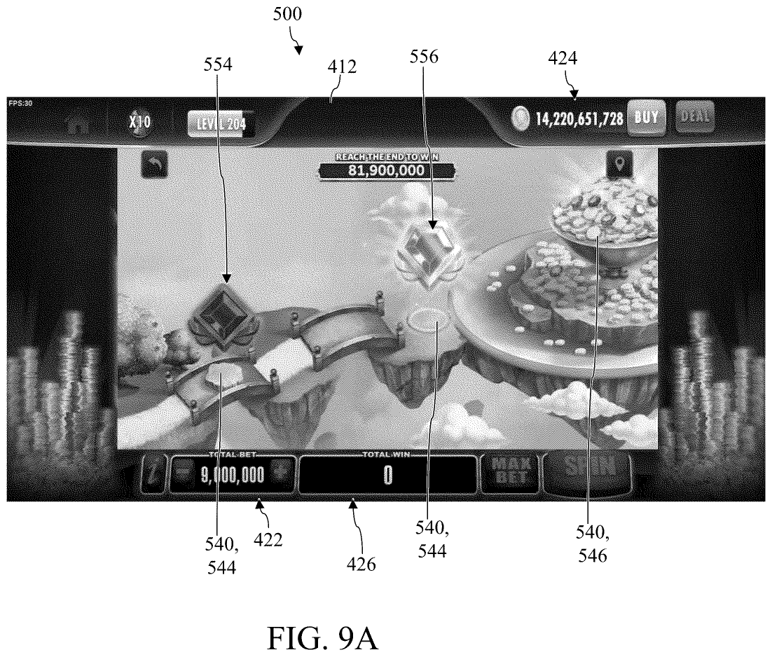

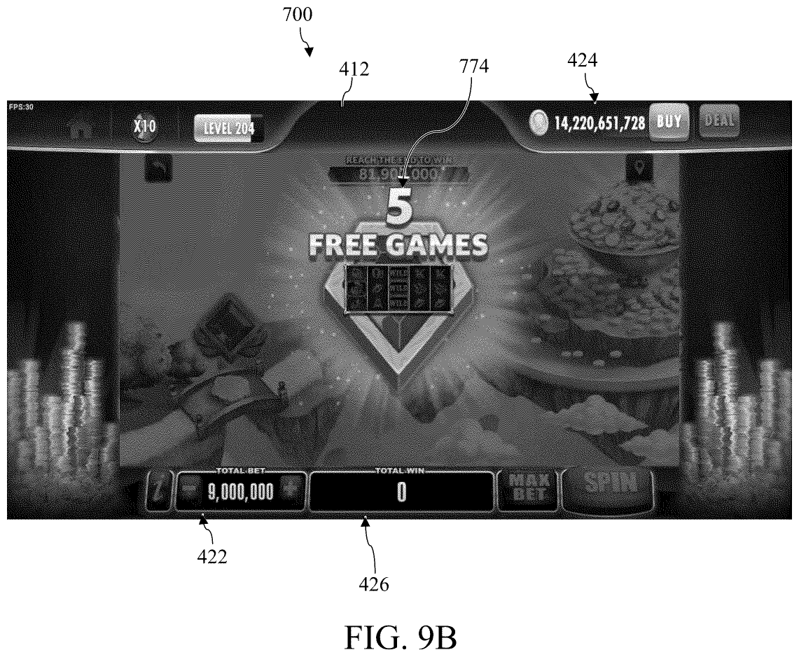

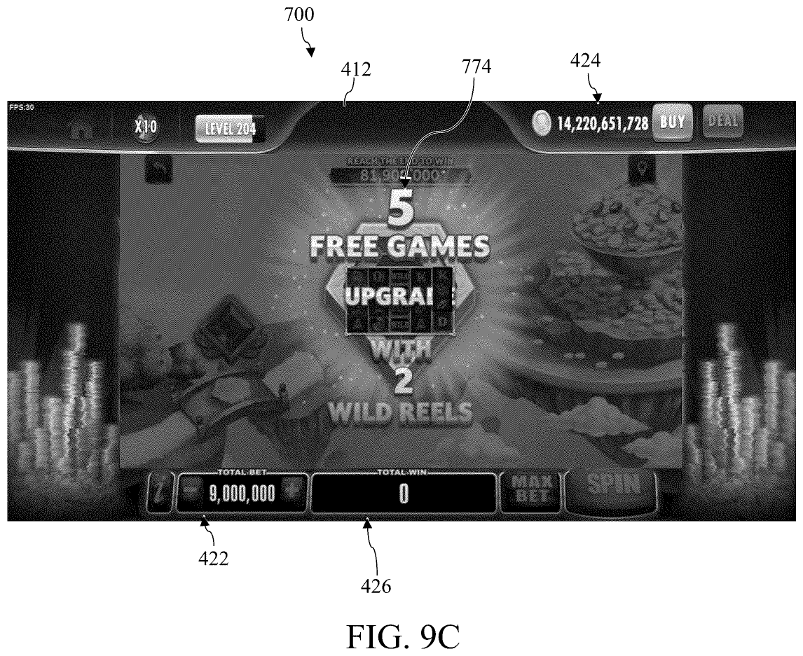

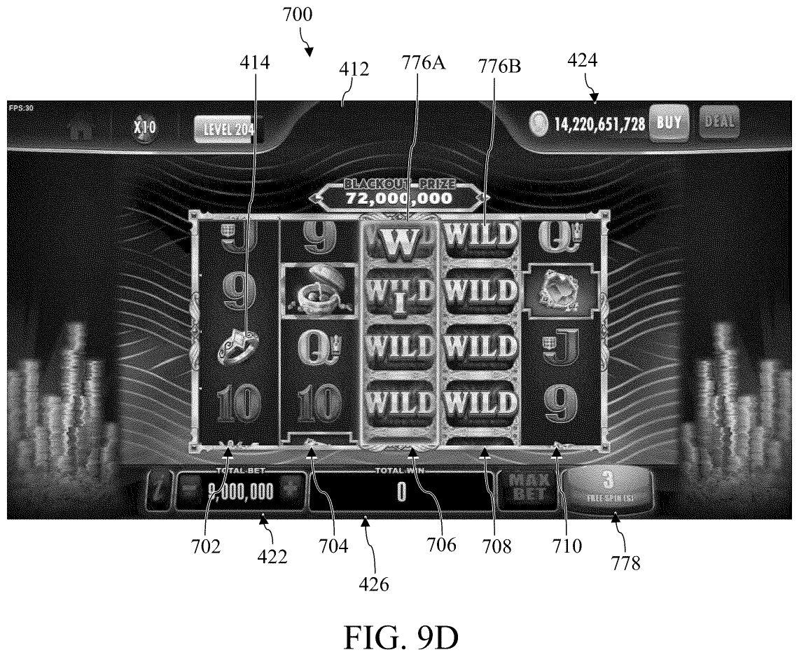

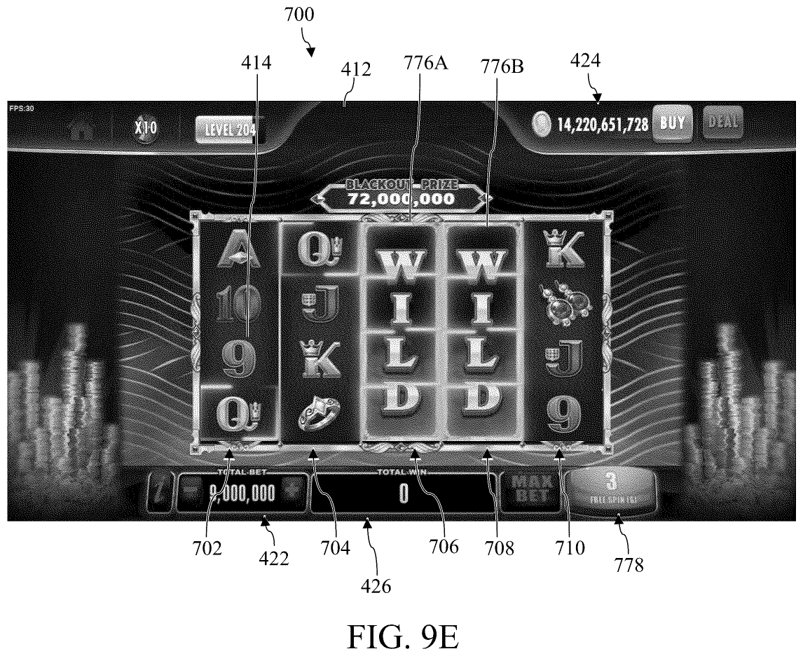

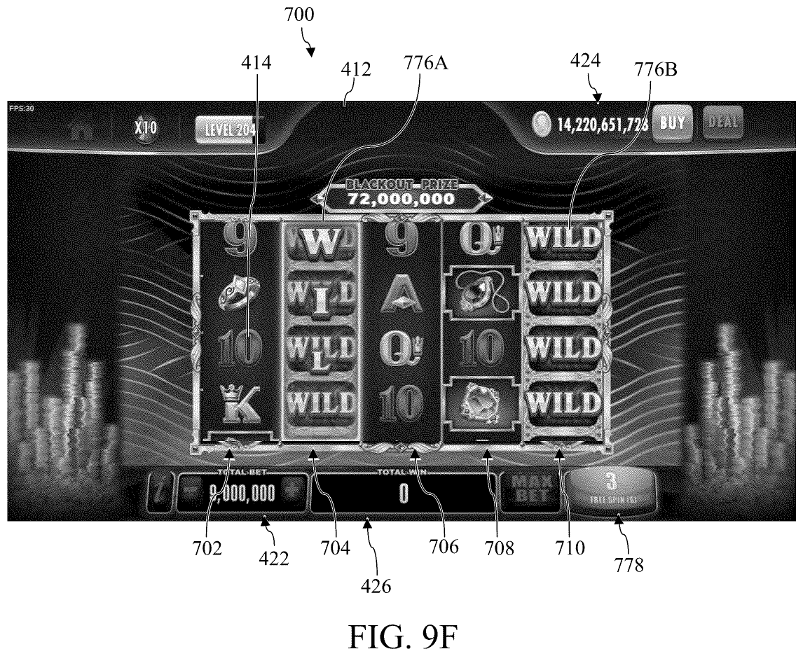

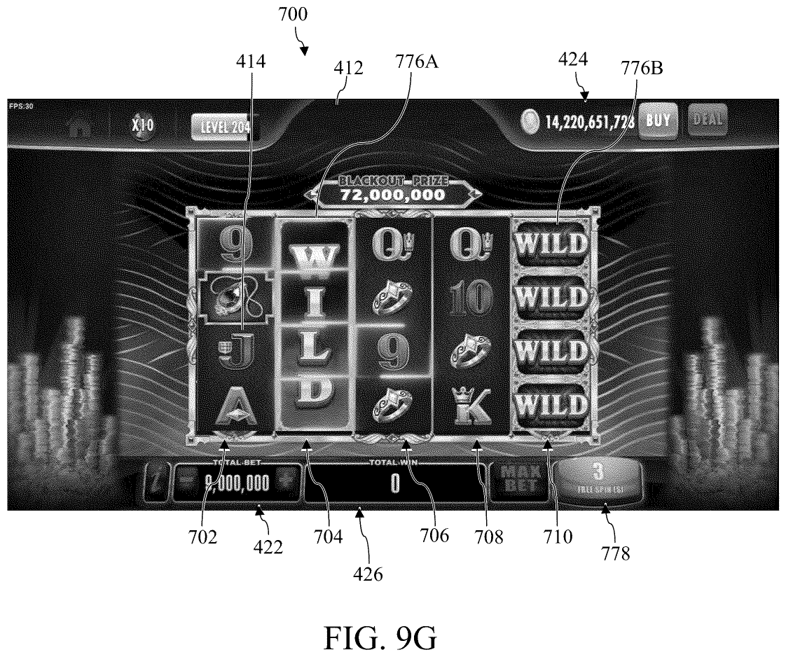

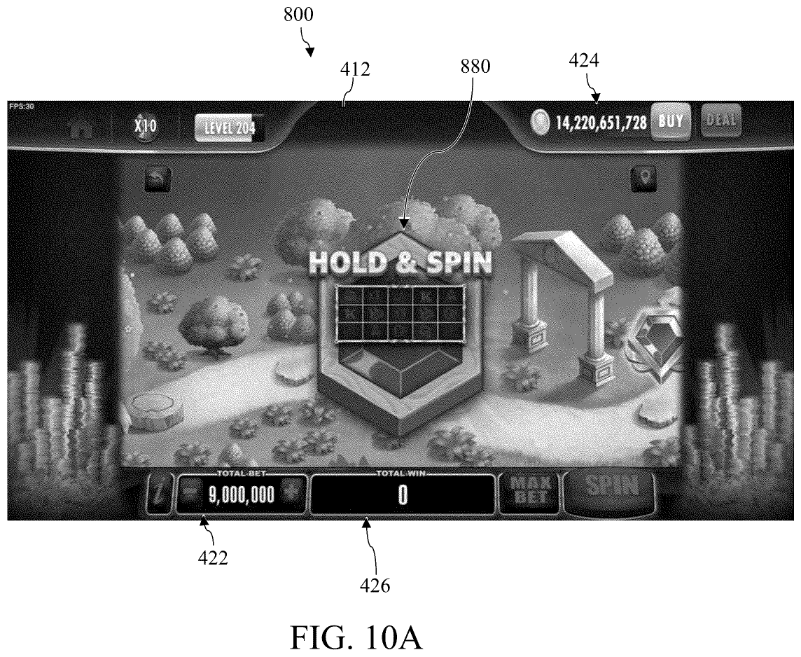

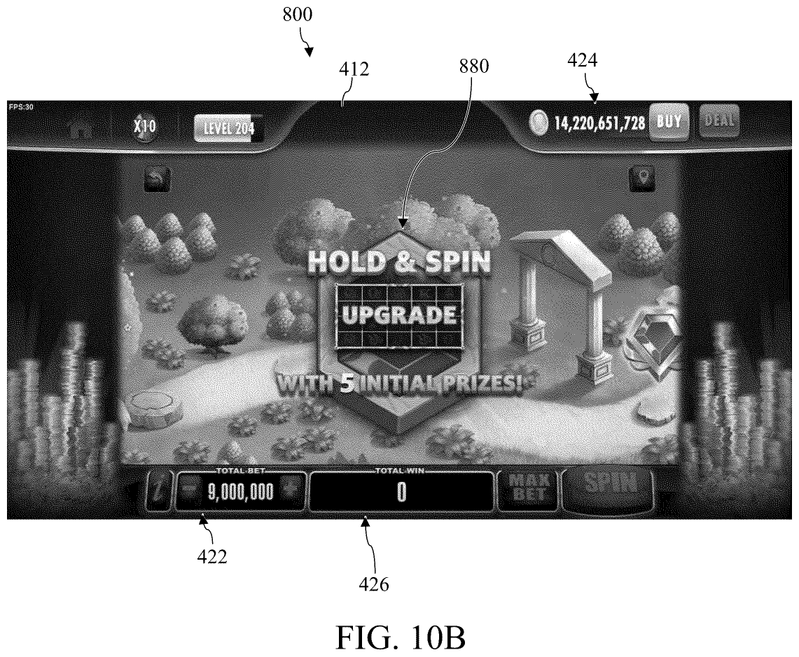

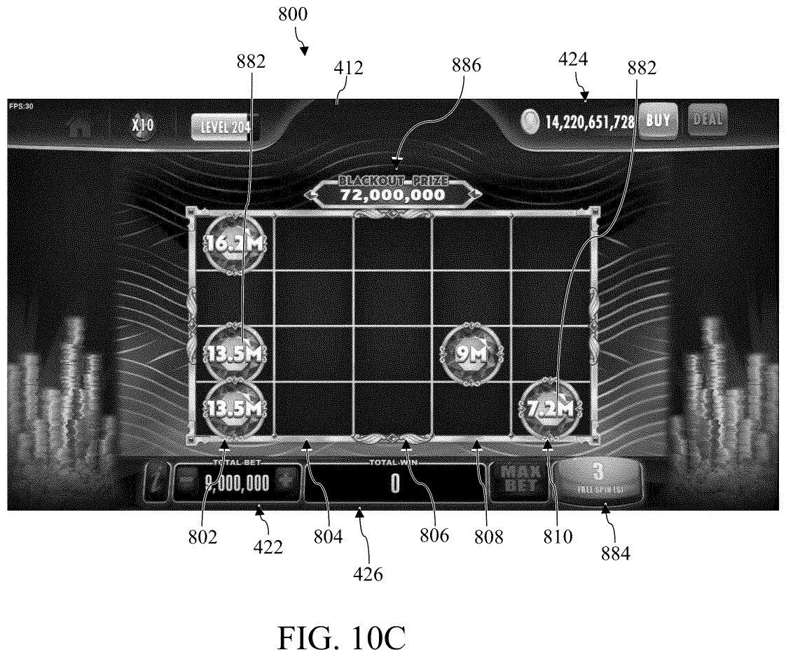

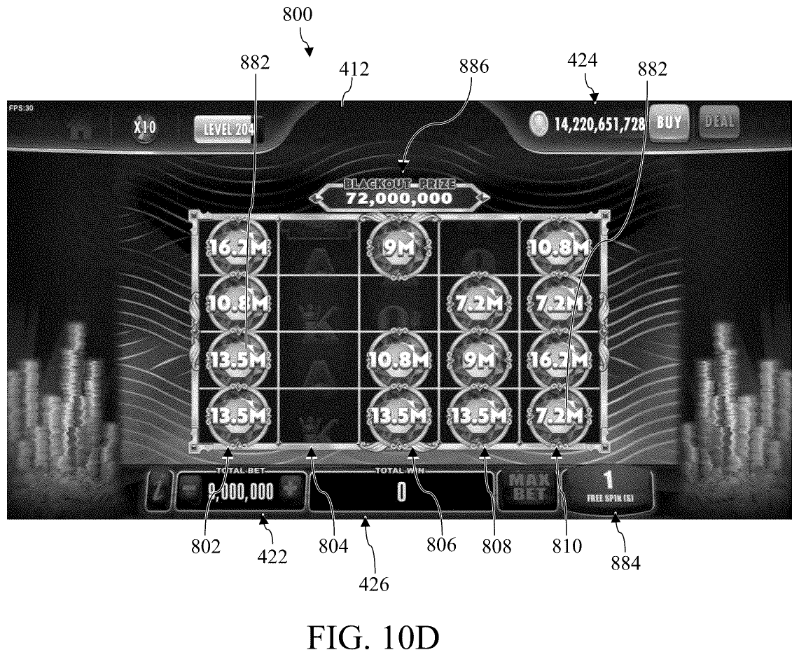

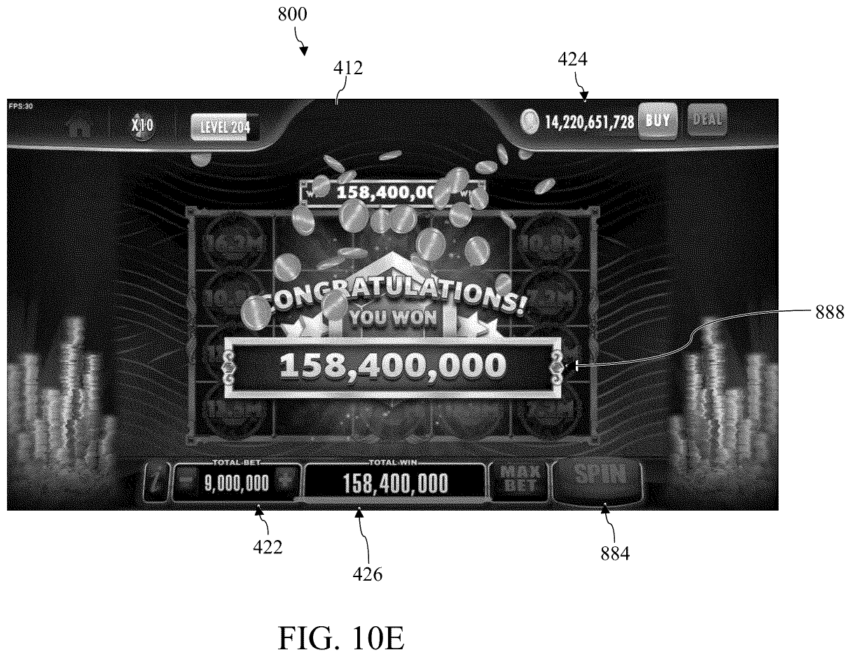

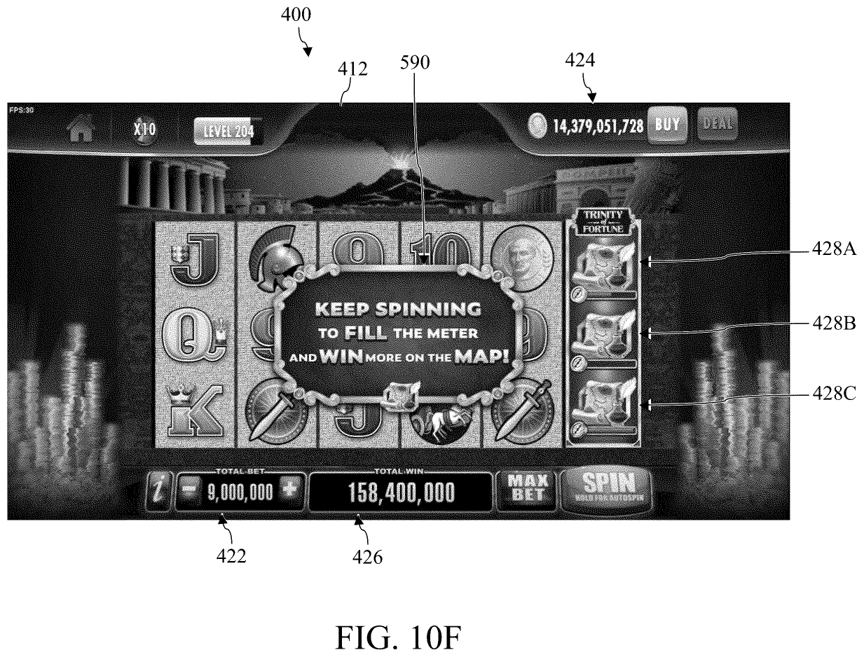

Each intermediate map space 544 in bonus map game 500 is associated with or corresponds to a bonus game or a prize value. In the exemplary embodiment shown in FIG. 6A, and prior to spinning a wheel (see, FIG. 6B), bonus map key 548 is displayed on display device 412. Bonus map key 548 includes a plurality of symbols 550-558 that represent the intermediate map space 544 and/or are displayed in conjunction with each intermediate map space 544 in bonus map game 500. For example, and as discussed herein, symbol 550 is associated a credit prize bonus (see, FIG. 6D), symbol 552 is associated with a bonus wheel game (see, FIGS. 7A and 7B), symbol 554 is associated with a pick bonus game 600 (see, FIGS. 8A-8D), symbol 556 is associated with a free spin bonus game 700 (see, FIGS. 9A-9G), and symbol 558 is associated with a hold-and-spin bonus game 800 (see, FIGS. 10A-10E). When a player lands on (e.g., bonus map game outcome) an intermediate map space 544 including one of these symbols 550-558, the associated credit prize bonus or additional bonus game (e.g., pick bonus game 600, free spin bonus game 700, etc.) is triggered and displayed on display device 412.

Turning to FIG. 6B, a user interface or screen shot displaying bonus map game 500 is shown. In the exemplary embodiment, and subsequent to activating or displaying bonus map game 500 and bonus map key 548 (see, FIG. 6A), a wheel 560 is displayed in bonus map game 500. Wheel 560 of bonus map game 500 includes a plurality of wedges 562. More specifically, wheel 560 is formed and/or divided into a plurality of distinct wedges 562 disposed circumferentially about a center reference point. In the non-limiting example shown, each wedge 562 for wheel 560 is sized equally. However, in other non-limiting examples (not shown), the plurality of wedges 562 may include distinct sizes with respect to one another. Each wedge of the plurality of wedges 562 depicts a number between “1” and “6.” The numbers depicted on each wedge 562 of wheel 560 represent a number of map spaces 540 a player can move during their turn in bonus map game 500.

Wheel 560 also includes at least one pointer 564. Pointer 564 is positioned adjacent to bonus wheel 560. During the spin and/or game play of bonus map game 500, pointer 564 visually identifies the wedge 562 of wheel 560 that has been selected and/or awarded to the player. As shown in FIG. 6B, pointer 564 is formed and/or depicted as a diamond shape. However, it should be understood that pointer 564 can be formed as any shape, symbol, figure, and/or graphic that can readily identify wedges 562 of wheel 560 during bonus map game 500.

Subsequent to a player tapping, touching, and/or engaging wheel 560 of bonus map game 500, wheel 560 spins and randomly selects one of the plurality of wedges 562 included therein. The number included or displayed within the selected wedge 562 of wheel 560 is the bonus map game outcome. More specifically, the number displayed within the selected wedge 562 of wheel 560 determines the number of map spaces 540 in which the player or user will move during their immediate turn of playing bonus map game 500. In the exemplary embodiment shown in FIG. 6B, wedge 562 including the number “6” has been selected and/or identified. As such, the player advances along the bronze map associated with and played on during bonus map game 500 until the player moves six (“6”) map spaces 540.

FIG. 6C shows a user interface or screen shot displaying bonus map game 500 after the player has spun wheel 560 and moved six map spaces 540 (see, FIG. 6B). In the exemplary embodiment, the player lands on or moves to intermediate map space 544 associated with and/or displaying symbol 550. As discussed herein, symbol 550 is associated with a credit prize bonus. Turning to FIG. 6D, and subsequent to moving to intermediate map space 544 displayed in FIG. 6C, display 412 provides a credit prize notification 566. That is, and as a result of the player moving to intermediate map space 544 including and/or associated with a credit prize bonus (e.g., symbol 550), a credit prize bonus is awarded to the player of bonus map game 500. Notification 566 indicates and/or visualizes for the player that they have been awarded “18,000,000” coins.

The credit prize value awarded during bonus map game 500 is dependent upon, at least in part, the progression within bonus map game 500 (e.g., distance from start), the specific map color or category (e.g., bronze map, silver map, gold map) in which bonus map game 500 is being played within, and the like. For example, the credit prize value for an intermediate map space 544 two (2) spaces from starting map space 542 may be less than the credit prize value for an intermediate map space 544 ten (10) spaces from starting map space 542. Additionally, or alternatively, the credit prize values awarded in the bronze map during bonus map game 500 are less than the credit prize values awarded in the silver map during bonus map game 500. Additionally, the credit prize values awarded in the gold map during bonus map game 500 are larger than the credit prize values awarded in the silver map during bonus map game 500. In other exemplary embodiments, the credit prize value awarded during bonus map game 500 for intermediate map spaces 544 including symbol 550 are randomly generated.

Subsequent to displaying notification 566 on display device 412, bonus map game 500 ends, and display 412 redisplays base reel game 400. For example, FIG. 6E shows a user interface or screen shot displaying base reel game 400 after the conclusion of bonus map game 500 (see, FIG. 6C). In exemplary embodiments, notification 568 is displayed on display device 412. Notification 568 provides instructions on display 412 indicating how continued plays of base reel game 400, and more specifically the displaying of bolt-on symbols 418 within the plurality of reels 402-410, can retrigger the playing of bonus map game 500. Additionally as shown in FIG. 6E, progress indicator 428C associated with the previously played bronze map in bonus map game 500 is reset. For example, the fill bar included in progress indicator 428C is emptied and/or is once again in a left-most position.

FIG. 7A shows a user interface or screen shot displaying bonus map game 500 after an initial spin of wheel 560. In the exemplary embodiment, the player lands on or moves to intermediate map space 544 associated with and/or displaying symbol 552. As discussed herein, symbol 552 is associated with bonus wheel game. Turning to FIG. 7B, and subsequent to moving to intermediate map space 544 including symbol 552, as displayed in FIG. 7A, display 412 provides wheel 560 once again. That is, and as a result of the player moving to intermediate map space 544 including and/or associated with bonus wheel game (e.g., symbol 552), wheel 560 is once again displayed on display device 412 and provides the player the opportunity to spin wheel 560 again. In spinning wheel 560 two times in a single turn of bonus map game 500, the player has the opportunity to play another bonus game (e.g., pick bonus game 600, free spin bonus game 700, etc.), while advancing further on the map (e.g., bronze map) toward the final map space 546 and the jackpot associated with final map space 546.

FIGS. 8A-8D are example user interfaces or screenshots of an example gameplay of bonus map game 500 played on a gaming device (e.g., gaming devices 104A-104X in FIG. 1, and/or gaming device 200 and/or mobile gaming device 256 in FIG. 2B). Specifically, FIGS. 8A-8D are example user interfaces or screenshots progressively displaying gameplay of a pick bonus game 600 triggered during bonus map game 500.

FIG. 8A shows a user interface or screen shot displaying bonus map game 500 after a spin of wheel 560. In the exemplary embodiment, the player lands on or moves to intermediate map space 544 associated with and/or displaying symbol 554. As discussed herein, symbol 554 is associated with pick bonus game 600. Turning to FIG. 8B, and subsequent to moving to intermediate map space 544 including symbol 554, display 412 provides pick bonus game 600. That is, and as a result of the player moving to intermediate map space 544 including and/or associated with pick bonus game 600 (e.g., symbol 554), pick bonus game 600 is triggered.

In the exemplary embodiment, display 412 shown in FIG. 8B provides a bonus game notification and/or animation 670 indicating that pick bonus game 600 has been triggered. In the example, pick bonus game 600 may replace and/or overlap bonus map game 500 and/or the map (e.g., bronze map) displayed during bonus map game 500. Additionally, FIG. 8B depicts pick bonus game 600 prior to a player selection. Pick bonus game 600 includes a plurality of selectable pick game symbols 672 that are presented to the player on display 412, and more specifically, within pick bonus game notification 670. In the non-limiting example, three selectable pick game symbols 672A, 672B, 672C are included in pick bonus game 600. In other non-limiting examples, the plurality of selectable pick game symbols 672 can include more or less than three (3) symbols and/or may continuously move in a random pattern. Additionally, as shown, pick bonus game 600 can include instructions or a player prompt 674 instructing the player to select one of the plurality of selectable pick game symbols 672A, 672B, 672C displayed on display 412. In exemplary embodiments, and as discussed herein, each of the plurality of selectable pick game symbols 672 are associated with a credit value to be awarded to the player upon selection. In other non-limiting examples, selectable pick game symbols 672A, 672B, 672C are associated with additional games (e.g., bonus wheel game, bonus free spin game 700, etc.).

FIG. 8C is an exemplary user interface or screen shot after one of the plurality of selectable pick game symbols 672A, 672B, 672C is selected by the player. In the non-limiting example, selectable pick game symbol 672B is selected and/or picked by the player. As a result, the associated credit value of “90M” is shown on display device 412.

In exemplary embodiments each credit value is generated at random or alternatively is assigned to one of the plurality of selectable pick game symbols 672A, 672B, 672C prior to the selection of the pick game symbols 672A, 672B, 672C. As a result, the selection of the corresponding credit values during pick bonus game 600 is random and/or equally weighted for the player. In another non-limiting example, the generated credit values for each of the pick game symbols 672A, 672B, 672C are biased and/or weighted prior to the selection of the selectable pick game symbols 672A, 672B, 672C. In the non-limiting example where the generated credit values are biased or weighted and are not assigned to the corresponding selectable pick game symbols 672A, 672B, 672C until after the player selects one of the selectable pick game symbols 672A, 672B, 672C. Rather, prior to the selection of one of the plurality of selectable pick game symbols 672A, 672B, 672C, one of the generated credit values is selected and/or determined based on, at least in part, a weighted factor and/or a lookup or weighted tables (e.g., FIG. 2A). Once selected using the weighted factors and/or lookup/weighted tables, the selected credit value is displayed in whichever selectable pick game symbols 672A, 672B, 672C the player selects during pick bonus game 600.

FIG. 8D is an exemplary user interface or screen shot after one of the plurality of selectable pick game symbols 672A, 672B, 672C is selected by the player, and prior to redisplaying base reel game 400. In the exemplary embodiment, unselected credit values associated within selectable pick game symbols 672A, 672C, respectively, are displayed on display 412. That is, and to increase player excitement, in response to one of the plurality of selectable pick game symbols 672A, 672B, 672C being selected, display 412 displays the credit values associated with the unselected pick game symbols 672A, 672C.

The credit values awarded during pick bonus game 600 are dependent upon, at least in part, the progression within bonus map game 500 (e.g., distance from start), the specific map color or category (e.g., bronze map, silver map, gold map) in which pick bonus game 600 is triggered within, and the like. For example, the credit values included in the pick bonus game 600 for an intermediate map space 544 two (2) spaces from starting map space 542 may be less than the credit values included in pick bonus game 600 for an intermediate map space 544 ten (10) spaces from starting map space 542. Additionally, or alternatively, the credit values offered in pick bonus game 600 triggered in the bronze map of bonus map game 500 are less than the credit values offered in the silver map during pick bonus game 600. Additionally, the credit values offered in pick bonus game 600 triggered in the gold map of bonus map game 500 are larger than the credit values offered in the silver map in bonus map game 500. In other exemplary embodiments, the credit values offered and/or awarded during pick bonus game 600 for intermediate map spaces 544 including symbol 554 are randomly generated.

FIGS. 9A-9G are example user interfaces or screenshots of an example gameplay of bonus map game 500 played on a gaming device (e.g., gaming devices 104A-104X in FIG. 1, and/or gaming device 200 and/or mobile gaming device 256 in FIG. 2B). Specifically, FIGS. 9A-9G are example user interfaces or screenshots progressively displaying gameplay of a free spin bonus game 700 triggered during bonus map game 500.

FIG. 9A shows a user interface or screen shot displaying bonus map game 500 after a spin of wheel 560. In the exemplary embodiment, the player lands on or moves to intermediate map space 544 associated with and/or displaying symbol 556. As discussed herein, symbol 556 is associated with free spin bonus game 700. Turning to FIGS. 9B and 9C, and subsequent to moving to intermediate map space 544 including symbol 556, display 412 provides a notification 774 that free spin bonus game 700 has been triggered. That is, and as a result of the player moving to intermediate map space 544 including and/or associated with free spin bonus game (e.g., symbol 556), notification 774 is provided on display 412 indicating that free spin bonus game 700 has been triggered. As discussed herein, free spin bonus game 700 is a reel based game having a predetermined number of free spins (e.g., requiring no coin or credit input from player to play), and is substantially similar to that of base reel game 400.

In non-limiting examples, different gameplay options of free spin bonus game 700 may be dependent upon the map in which free spin bonus game 700 is activated. More specifically, although a free spin bonus game 700 can be activated in each of the distinct maps (e.g., bronze map, silver map, gold map), gameplay options, attributes, and/or characteristics of free spin bonus game 700 may vary depending on which map the players are playing bonus map game 500. For example, FIG. 9B shows a user interface or screen shot displaying notification 774 indicating that free spin bonus game 700 has been activated while playing bonus map game 500 on the bronze map. Here, notification 774 indicates that free spin bonus game 700 includes five (5) free spins on a plurality of reels 702-710. However, it is to be understood that the number of free spins depicted in notification 774 for free spin bonus game can be any number of predetermined number of free spins, and/or is randomly determined prior to free spin bonus game 700 being triggered and displayed on display device 412.

In this example, free spin bonus game 700 includes three symbol positions for each reel 702-710. As such, free spin bonus game 700 awarded, triggered, and/or activated during bonus map game 500 played on bronze map includes a 3×3×3×3×3 arrangement. Additionally in the non-limiting example, reels 702-710 included in free spin bonus game 700 include a single WILD reel 776. As shown in FIG. 9B, reel 706 includes a WILD reel 776. As discussed herein, during free spin bonus game 700 wild reel 776 represents an entire reel 702-710 that may only display wild symbols during each spin or outcome. Additionally as discussed herein, wild reel 776 may change reels after each spin or play of free spin bonus game 700.

Alternatively, FIG. 9C shows a user interface or screen shot displaying notification 774 indicating that free spin bonus game 700 has been activated while playing bonus map game 500 on the silver map. In the exemplary embodiment, notification 774 indicates that free spin bonus game 700 includes five (5) free spins on a plurality of reels 702-710. In the example where free spin bonus game 700 is activated while playing bonus map game 500 in the silver map, reels 702-710 for free spin bonus game 700 are upgraded. That is, each reel 702-710 for free spin bonus game 700 includes four (4) symbol positions. As such, free spin bonus game 700 awarded, triggered, and/or activated during bonus map game 500 played on silver map includes a 4×4×4×4×4 arrangement. Additionally in the non-limiting example, reels 702-710 included in free spin bonus game 700 include two WILD reels 776A, 776B. As shown in FIG. 9C, reels 706, 710 include WILD reels 776A, 776B, respectively.

In exemplary embodiments, notification 774 indicates that free spin bonus game 700 triggered while playing bonus map game 500 on the gold map can include distinct gameplay options, attributes, and/or characteristics. For example, free spin bonus game 700 triggered or activated while playing bonus map game 500 on the gold map includes five (5) free spins on a plurality of reels 702-710. Additionally, reels 702-710 for free spin bonus game 700 are upgraded further when playing bonus map game 500 in the gold map. That is, each reel 702-710 for free spin bonus game 700 can include five (5) symbol positions. As such, free spin bonus game 700 awarded, triggered, and/or activated during bonus map game 500 played on the gold map includes a 5×5×5×5×5 arrangement. Reels 702-710 included in free spin bonus game 700 triggered in the gold map can also include two WILD reels 776A, 776B.

FIG. 9D is an example user interface or screen shot displaying free spin bonus game 700 during a free spin and after the player has already initiated and spun reels 702-710 one (1) time. Free spin bonus game 700 includes a free spin indicator 778. Prior to spinning reels 702-710 included in free spin bonus game 700 and/or playing free spin bonus game 700, spin indicator 778 displays and/or presents the predetermined number of free spins for free spin bonus game 700. In the exemplary embodiment, the predetermined number of free spins is five (5) free spins for free spin bonus game 700 (see, FIG. 9C). However, and as shown in FIG. 9D, display 412 depicts free spin bonus game 700 while reels 702-710 are spinning to ultimately display the second game outcome (see, FIG. 9E). As a result, free spin indicator 778 depicts “3 FREE SPIN(S)” for the remaining free spins of free spin bonus game 700.

Free spin bonus game 700 displayed on display 412 includes the plurality of reels 702-710 similar to those included in base reel game 400. Additionally, each reel 702-710 included in free spin bonus game 700 includes the plurality of game symbols 414 including graphic game symbols 416. In exemplary embodiments, reels 702-710 included in free spin bonus game 700 are substantially similar to those included in base reel game 400 and include substantially similar game symbols 414. Alternatively, reels 702-710 included in free spin bonus game 700 are substantially different from those included in base reel game 400 and/or include distinct game symbols 414.

Additionally, and because free spin bonus game 700 was triggered while playing bonus map game 500 in the silver map, reels 702-710 include two WILD reels 776A, 776B. During the second free spin, as shown in FIG. 9D, WILD reel 776A is included in or displayed within reel 706, while WILD reel 776B is included in or displayed within reel 708. WILD reels 776A, 776B may change position and/or reels 702-710 during each free spin of the free spin bonus game 700 (see, FIG. 9F). As shown in FIG. 9D, WILD reels 776A, 776B include a wild symbol in each of the symbol positions for the assigned reel. In exemplary embodiments, each wild symbol increases the potential winning paylines and/or winning patterns for free spin bonus game 700.

FIG. 9E is an example user interface or screen shot displaying free spin bonus game 700 subsequent to the spinning of reels 702-710. In exemplary embodiments, FIG. 9E is displaying an outcome of the second free spin for free spin bonus game 700.

FIGS. 9F and 9G are example user interfaces or screen shots displaying subsequent free spins during free spin bonus game 700. More specifically, FIG. 9F shows an example user interface or screen shot during a subsequent free spin in free spin bonus game 700, and FIG. 9G shows an example user interface or screen shot depicting an outcome of the subsequent free spin made during free spin bonus game 700. In exemplary embodiments, WILD reels 776A, 776B move to a distinct reel 702-710 during a subsequent free spin within free spin bonus game 700. As shown, WILD reel 776A in the subsequent free spin is included within reel 704, while WILD reel 776B is in reel 710.

FIGS. 10A-10F are example user interfaces or screenshots of an example gameplay of bonus map game 500 played on a gaming device (e.g., gaming devices 104A-104X in FIG. 1, and/or gaming device 200 and/or mobile gaming device 256 in FIG. 2B). Specifically, FIGS. 10A-10F are example user interfaces or screenshots progressively displaying gameplay of a hold-and-spin bonus game 800 triggered during bonus map game 500.

For example, FIG. 10A shows a user interface or screen shot displaying notification 880 indicating that hold-and-spin bonus game 700 has been activated while playing bonus map game 500 on the silver map. In exemplary embodiments, notification 880 is displayed on display device 412 after the player lands on or moves to intermediate map space 544 associated with and/or displaying symbol 558. As discussed herein, symbol 558 is associated with hold-and-spin bonus game 800. Subsequent to moving to intermediate map space 544 including symbol 558, display 412 provides notification 880 indicating hold-and-spin bonus game 800 has been triggered.

In non-limiting examples, and similar to hold-and-spin bonus game 800, different gameplay options of hold-and-spin bonus game 800 may be dependent upon the map in which hold-and-spin bonus game 800 is activated. More specifically, although hold-and-spin bonus game 800 can be activated in each of the distinct maps (e.g., bronze map, silver map, gold map), gameplay options, attributes, and/or characteristics of hold-and-spin bonus game 800 may vary depending on which map the players are playing bonus map game 500.

In the exemplary embodiment shown in FIG. 10A, each reel matrix column 802-810 (see, FIG. 10C) for hold-and-spin bonus game 800 includes independent reels. More specifically, each reel column 802-810 for hold-and-spin bonus game 800 includes a plurality of independent reels, where the number of independent reels is based on the number of rows included in each reel column 802-810. As such, hold-and-spin bonus game 800 awarded, triggered, and/or activated during bonus map game 500 played on bronze map includes a 3×3×3×3×3 arrangement formed as fifteen (15) independent reels. Alternatively, FIG. 10B shows a user interface or screen shot displaying notification 880 indicating that hold-and-spin bonus game 800 has been activated while playing bonus map game 500 on the silver map. In the exemplary embodiment, notification 880 indicates that hold-and-spin bonus game 800 and reel columns 802-810 for hold-and-spin bonus game 800 are upgraded. That is, each reel column 802-810 for hold-and-spin bonus game 800 includes four (4) independent reels. As such, hold-and-spin bonus game 800 awarded, triggered, and/or activated during bonus map game 500 played on silver map includes a 4×4×4×4×4 arrangement formed as twenty (20) independent reels. Additionally in the non-limiting example, reel columns 802-810 included in hold-and-spin bonus game 800 include five (5) initial prizes. More specifically, notification 880 indicating that hold-and-spin bonus game 800 has been activated while playing bonus map game 500 on the silver map also identifies that five (5) initial prizes will be awarded and/or included within five independent reels included in reel columns 802-810 prior to the first spin of the reels during hold-and-spin bonus game 800.

In exemplary embodiments, notification 880 indicates that hold-and-spin bonus game 800 triggered while playing bonus map game 500 on the gold map can include distinct gameplay options, attributes, and/or characteristics. For example, hold-and-spin bonus game 800 triggered or activated while playing bonus map game 500 on the gold map includes additionally upgraded reels included in reel columns 802-810. Each reel column 802-810 for hold-and-spin bonus game 800 triggered in the gold map can include five (5) independent reels. As such, hold-and-spin bonus game 800 awarded, triggered, and/or activated during bonus map game 500 played on the gold map includes a 5×5×5×5×5 arrangement formed as twenty-five (25) independent reels. Reel columns 802-810 included in hold-and-spin bonus game 800 triggered in the gold map can also include seven (7) initial prizes awarded within seven independent reels included in reel columns 802-810 prior to the first spin of reels during hold-and-spin bonus game 800.

FIGS. 10C-10E show exemplary user interfaces or screenshots of a sequence of hold-and-spin bonus game 800 initiated and/or triggered within bonus map game 500 (see, FIG. 10B) played in the silver map. FIG. 10C is an example user interface or screen shot displaying hold-and-spin bonus game 800 prior to initiating and spinning of reels included in reel columns 802-810. Hold-and-spin bonus game 800 includes a plurality of hold-and-spin reel columns 802-810 formed from a plurality of independent reels displaying a plurality of prize symbols 882. Prior to “spinning” the plurality of reels, a spin number indicator 884 can display and/or present a predetermined number of spins for hold-and-spin bonus game 800. In exemplary embodiments, the predetermined number of bonus spins for hold-and-spin bonus game 800 is three (3). The user or player of hold-and-spin bonus game 800 “spins” the plurality of reels included in reel columns 802-810 to attempt to display additional prize symbols 882, beyond the five (5) initial prizes awarded at the triggering of hold-and-spin bonus game 800. Each spin in which one or more prize symbol 882 lands or is displayed on at least one reel included in reel columns 802-810 of hold-and-spin bonus game 800 resets the spin number indicator back to the predetermined number of spins for hold-and-spin bonus game 800. In another non-limiting example, the number of bonus spins are not reset in response to displaying prize symbols 882 during hold-and-spin bonus game 800. Rather, the player can spin hold-and-spin bonus game 800 the predetermined number of spins (e.g., three spins), before hold-and-spin bonus game 800 ends. Additionally, hold-and-spin bonus game 800 displayed on display device 412 includes a blackout prize value 886. Black out prize value 886 is awarded to the player in response to each independent reel of the reel columns 802-810 including prize symbol 882 at the conclusion of hold-and-spin bonus game 800.

FIG. 10D is an exemplary user interface or screen shot of an outcome of hold-and-spin bonus game 800. That is, FIG. 10D is an exemplary embodiment after the player has spun the plurality of independent reels included in reel columns 802-810 of hold-and-spin bonus game 800 at least once to display a plurality of prize symbols 882 thereon. Each time prize symbol 882 is displayed within one of the plurality of independent reels included in reel columns 802-810, the displayed prize symbol 882 remains displayed during subsequent game play of hold-and-spin bonus game 800. In the exemplary embodiment, spin number indicator 884 also indicates that “1” free spin remains. As discussed herein, each time the independent reels are spun and new prize symbols 882 do not appear in any reels included in reel columns 802-810, the number of free spins remaining for hold-and-spin bonus game 800 is reduced by “1.” In the exemplar embodiment, FIG. 10D shows user interface or screen shot hold-and-spin bonus game 800 after two consecutive spins that do not result in addition prize symbols 882 being displayed in reels of reel columns 802-810.

At the end of hold-and-spin bonus game 800, the prize values corresponding to and/or included with prize symbols 882 displayed in each independent reel of reel columns 802-810 are awarded to the player. As shown in FIG. 10E, prize notification 888 is provided on display device 412 at the conclusion of hold-and-spin bonus game 800, including the total value of all prize values included in prize symbols 882 displayed during hold-and-spin bonus game 800 (e.g., “158,400,000”).

In non-limiting examples, the generated prize values for each displayed prize symbol 882 is random and/or predetermined. In other exemplary embodiments, as each distinct prize symbol 882 is displayed during hold-and-spin bonus game 800, prize values generated and/or associated for subsequently displayed prize symbols 882 can remain the same or increase.

Subsequent to displaying notification 888 on display device 412, hold-and-spin bonus game 800 ends, and display 412 redisplays base reel game 400. For example, FIG. 10F shows a user interface or screen shot displaying base reel game 400 after the conclusion of hold-and-spin bonus game 800 (see, FIG. 10C 10E). In exemplary embodiments, notification 590 is displayed on display device 412. Notification 590, similar to notification 568 (see, FIG. 6E), provides instructions on display 412 indicating how continued plays of base reel game 400, and more specifically the displaying of bolt-on symbols 418 within the plurality of reels 402-410, can retrigger the playing of bonus map game 500. Additionally as shown in FIG. 10F, progress indicator 428B associated with the previously played silver map in bonus map game 500 is reset. For example, the fill bar included in progress indicator 428B is emptied and/or is once again in a left-most position.

FIGS. 11A-11D are example user interfaces or screenshots of an example gameplay of bonus map game 500 played on a gaming device (e.g., gaming devices 104A-104X in FIG. 1, and/or gaming device 200 and/or mobile gaming device 256 in FIG. 2B). Specifically, FIGS. 11A and 11B are example user interfaces or screenshots displaying gameplay of bonus map game 500 subsequent to the player reaching final map space 546 and FIGS. 11C and 11D are example user interfaces or screenshots of the redisplaying of base reel game 400 subsequent to the player reaching final map space 546.

As similarly discussed herein, player spins wheel 560 to progress through the plurality of map spaces 540 displayed during bonus map game 500. In an exemplary embodiment, player spins wheel 560 and moves the number of spaces equal to the number associated with the selected wedge 562 of wheel 560. As shown in FIG. 11A, the player reaches final map space 546 for the bronze map played within bonus map game 500. Upon reaching final map space 546, prize notification 592 is provided to display 412, as shown in FIG. 11B, indicating to the player that they have completed the map and been awarded a completion prize value 594 (e.g., “45,000,000”).

Subsequent to displaying prize notification 592 on display device 412, bonus map game 500 ends, and display 412 redisplays base reel game 400. For example, FIG. 11C shows a user interface or screen shot displaying base reel game 400 after completing the bronze map in bonus map game 500 (see, FIGS. 11A and 11B). In exemplary embodiments, notification 595 is displayed on display device 412. Notification 595 provides instructions on display 412 indicating how continued plays of base reel game 400, and more specifically the displaying of bolt-on symbols 418 within the plurality of reels 402-410, can retrigger the playing of bonus map game 500, and allow the player to complete the bronze map again. Additionally as shown in FIG. 11C, progress indicator 428C associated with the previously played bronze map in bonus map game 500 is reset. For example, the fill bar included in progress indicator 428B is emptied and/or is once again in a left-most position (see, FIG. 11D).

Additionally in the exemplary embodiment shown in FIGS. 11C and 11D, a completion indicator 596 is included within progress indicator 428C. That is, subsequent to the completion of the bronze map during bonus map game 500 (e.g., reaching final map space 546), completion indicator 596 is provided, displayed, and/or included within progress indicator 428C. As shown, completion indicator 596 includes a graphic as well as a numerical value indicating how many times the player has completed the bronze map during bonus map game 500. Each time the bronze map is completed during bonus map game 500, the numerical value included in completion indicator 596 is increased by one (1).

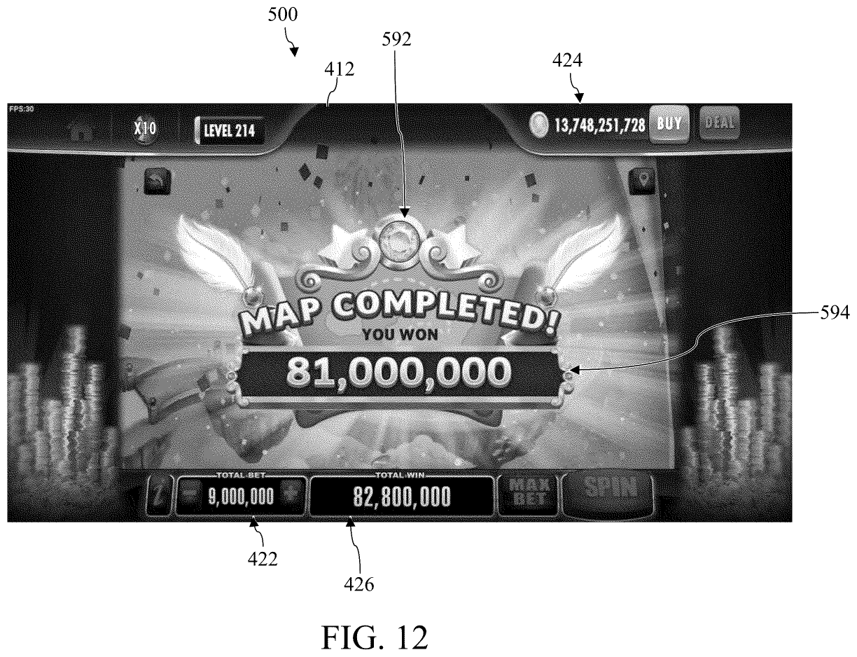

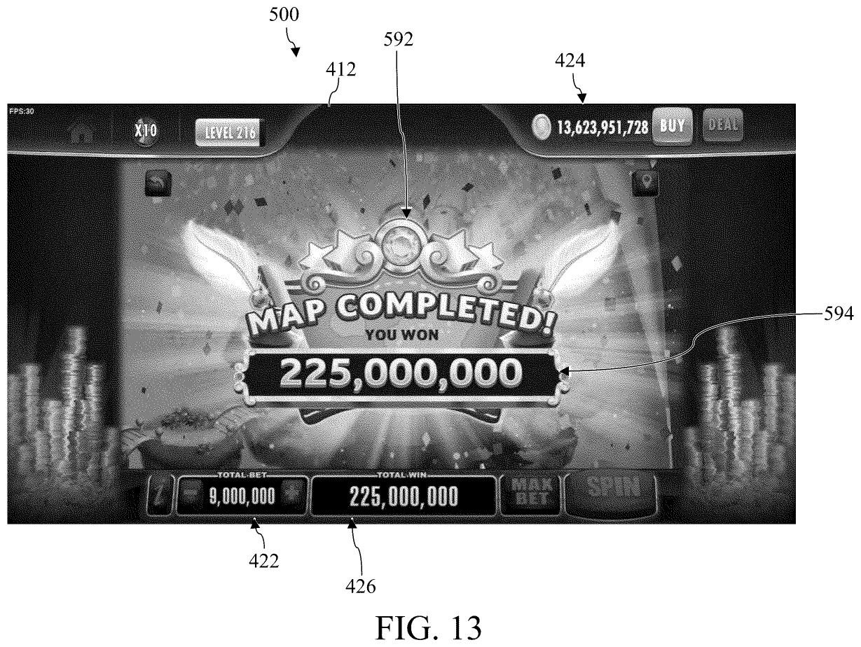

Completion prize values 594 differ for each map (e.g., bronze map, silver map, gold map) played in bonus map game 500. In exemplary embodiments, completion prize value 594 awarded in the bronze map during bonus map game 500 is less than completion prize value 594 awarded in the silver map during bonus map game 500 (see, FIG. 12). Additionally, completion prize value 594 awarded in the gold map during bonus map game 500 (see, FIG. 13) are larger than completion prize value 594 awarded in the silver map during bonus map game 500.

FIG. 12 shows an example user interface or screenshot of an example gameplay of bonus map game 500 played on the silver map. In exemplary embodiments, the player has reached final map space 546 in the silver map while playing bonus map game 500 and presented with prize notification 592. Prize notification 592 indicates to the player that they have completed the silver map and been awarded completion prize value 594 (e.g., “81,000,000”).

FIG. 13 shows an example user interface or screenshot of an example gameplay of bonus map game 500 played on the gold map. In exemplary embodiments, the player has reached final map space 546 in the gold map while playing bonus map game 500. Prize notification 592 displayed on display device 412 upon reaching final map space 546 in the gold map indicates that the player has completed the gold map and has been awarded completion prize value 594 (e.g., “225,000,000”).

Upon completion of the maps during bonus map game 500, the player is returned to starting map space 542 during subsequent playthroughs. That is, after the player has completed the map by reaching final map space 546, during the next immediate play of bonus map game 500 within the completed map, the player will return to starting map space 542 before spinning wheel 560 (see, FIG. 6A).

In an exemplary embodiment, completion prize value 594 for completing the map during bonus map game 500 remains the same for each playthrough. As such, each time the player of bonus map game 500 completes the map (e.g., bronze map), the player is awarded the same completion prize value 594 (e.g., “45,000,000”). In exemplary embodiments, completion prize value 594 can increase or alternatively be randomly selected, each time the player of bonus map game 500 completes the map. In some embodiments, completion prize value 594 may be a progressive jackpot prize.

Additionally in exemplary embodiments, the position or plurality of distinct map spaces 540 including the various symbols 550-558 associated within distinct bonus games played within bonus map game 500 may remain consistent each time the player of bonus map game 500 completes the map. Alternatively, each time the player of bonus map game 500 completes the map, symbols 550-558 are associated with distinct map spaces 540 within the map during subsequent playthroughs of bonus map game 500. For example, symbol 554 is associated with the third intermediate map space 544 in the bronze map during an initial playthrough of bonus map game 500. Subsequent to completing the bronze map during bonus map game 500 (e.g., reaching final map space 546), symbol 554 is associated with the fifth intermediate map space 544 during the subsequent playthrough of bronze map during bonus map game 500.

During play of base reel game 400, bolt-on symbols 418A, 418B, 418C corresponding to each distinct map (e.g., bronze map, silver map, gold map) and progress indicator 428A, 428B, 428C, respectively, can be displayed regardless of a wager amount. As such, bonus map game 500 played on any of the various maps can be triggered, regardless of a wager amount, so long enough bolt-on symbols 418A, 418B, 418C are displayed in base reel game outcomes to fill the fillable bars included in progress indicators 428A, 428B, 428C.

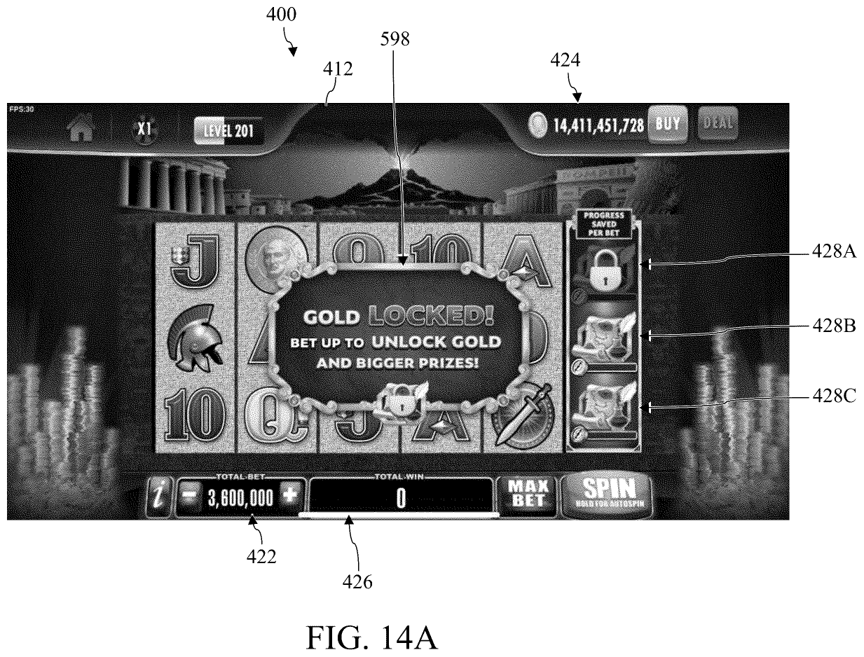

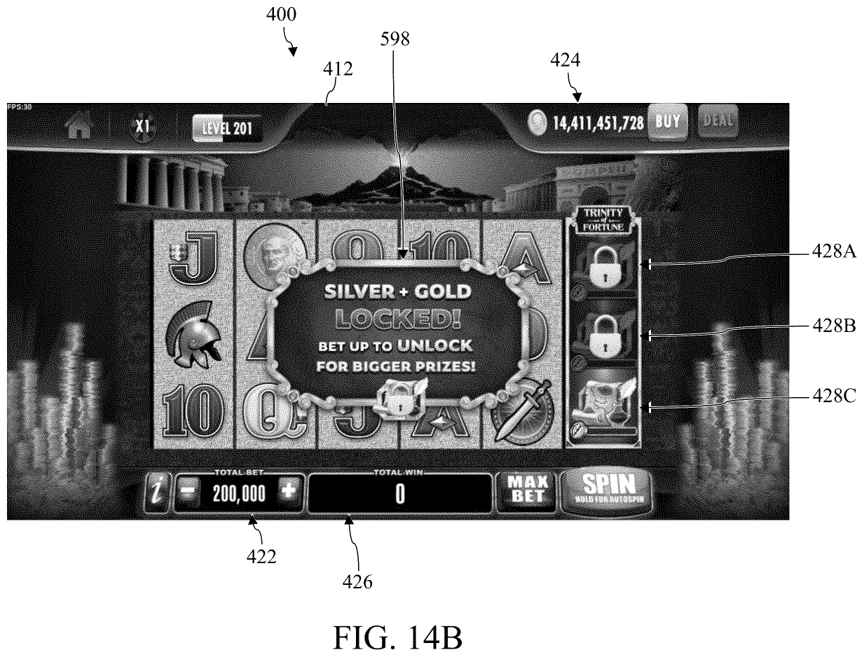

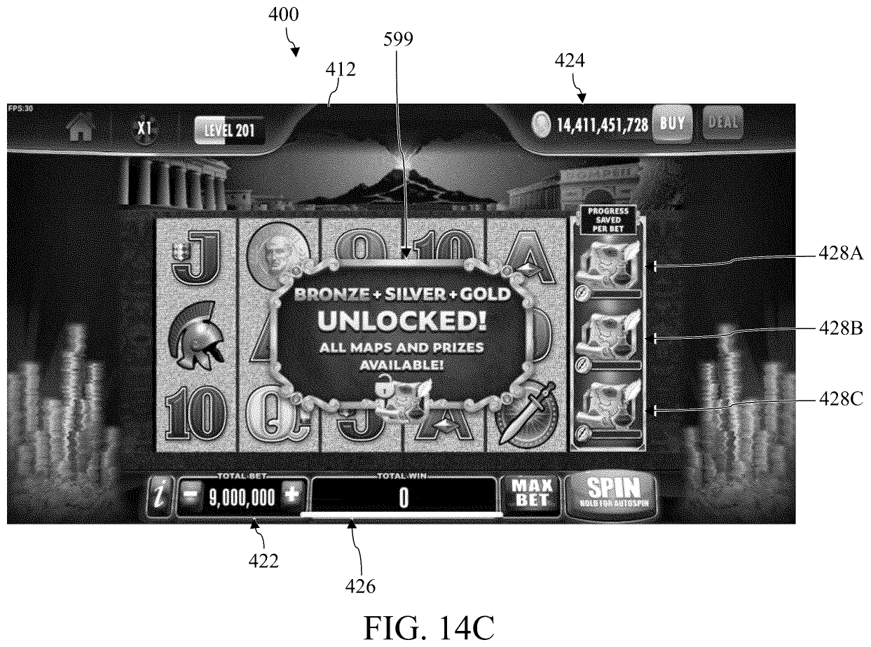

Alternatively, and dependent upon a wager amount for each spin during base reel game 400, only a portion of bolt-on symbols 418A, 418B, 418C are displayed during base reel game 400. That is, in order to display bolt-on symbols 418A, 418B, 418C during base reel game 400, with the hopes to trigger bonus map game 500 in desired maps (e.g., gold map), the player must wager above a predetermined bet threshold. FIG. 14A shows an example user interface or screenshot of an example gameplay of base reel game 400. In the exemplary embodiment, lock notification 598 is provided on display device 412 indicating to the player that the gold map is “locked” (e.g., “GOLD LOCKED! BET UP TO UNLOCK GOLD AND BIGGER PRIZES”). Additionally as shown in FIG. 14A, progress indicator 428A includes a graphic or symbol (e.g., key lock) illustrating that progress indicator 428A, and in turn the gold map, is locked. Notification 598 is provided on display device 412 because of the wager for base reel game 400 being below the predetermined bet threshold. For example, to maintain the gold map as a playable option during base reel game 400, the wager for base reel game 400 must be equal to or above “4,000,000” credits or credit value. When the wager is below the predetermined threshold (e.g., “3,600,000”) display device 412 provides lock notification 598 informing the player that the gold map is now locked. After locking the gold map, and during subsequent plays of base reel game 400, bolt-on symbol 418A corresponding to the gold map and/or progress indicator 428A are not presented with the plurality of game symbols 414 in reels 402-410. Alternatively, bolt-on symbol 418A corresponding to the gold map and/or progress indicator 428A are presented with the plurality of game symbols 414 in reels 402-410 in outcomes of base reel game 400, however, the appearance of bolt-on symbol 418A in the outcome of base reel game 400 does not progress the fillable bar in progress indicator 428A, as similarly discussed herein.

FIG. 14B shows another example user interface or screenshot of an example gameplay of base reel game 400. In the exemplary embodiment, lock notification 598 is provided on display device 412 indicating to the player that the gold map and the silver map are “locked” (e.g., “SILVER+GOLD LOCKED! BET UP TO UNLOCK FOR BIGGER PRIZES”). As shown in FIG. 14B, progress indicators 428A, 428B each include a graphic or symbol (e.g., key lock) illustrating that progress indicators 428A, 428B and in turn the gold map and silver map, respectively, are locked. Notification 598 is provided on display device 412 as a result of the wager for base reel game 400 being below a distinct predetermined bet threshold. For example, to maintain both the gold and silver maps during base reel game 400, the wager for base reel game 400 must be equal to or above “250,000” credits or credit value. When the wager is below the predetermined threshold (e.g., “200,000”) display device 412 provides lock notification 598 informing the player that the gold and silver maps are now locked.

If the player increases the wager amount for base reel game 400, at least some of the locked maps are unlocked. More specifically, when the player of base reel game 400 increases the wager of the game to be equal to or above the predetermined bet threshold (e.g., “4,000,000”) and/or the distinct predetermined bet threshold (e.g., “200,000”) previously locked maps associated with bonus map game 500 are unlocked. FIG. 14C shows an example user interface or screenshot of an example gameplay of base reel game 400. In the exemplary embodiment, and subsequent to the player increasing the wager amount to “9,000,000”, unlock notification 599 is provided on display device 412. Unlock notification 599 indicates to the player that the gold map and the silver map are “unlocked” (e.g., “BRONZE+SILVER+GOLD UNLOCKED! ALL MAPS AND PRIZES AVAILABLE”). As shown in FIG. 14C, progress indicators 428A, 428B now have any previous lock graphic or symbol (e.g., key lock) removed to identify that progress indicators 428A, 428B are unlocked and playable.

As discussed herein, each of the bolt-on symbols 418A, 418B, 418C included in base reel game 400 are defined in at least one distinct stop position table that defines a stop position of each of the plurality of bolt-on symbols 418 within each reel 402-410. When specific maps (e.g., gold maps) are locked based on the wager for base reel game 400 being below a predetermined bet threshold, specific stop positions defined in the distinct stop position table that include bolt-on symbols 418A, 418B, 418C corresponding to the locked map may no longer be selectable by RNG engine 316 of game processing architecture 300. In another exemplary embodiment, each individual map or combination of maps can include a distinct stop position table that defines the bolt-on symbols 418 and a stop position corresponding to and/or associated with one of the plurality of reels 402-410 included in base reel game 400. For example, when the gold map becomes locked, RNG engine 316 of game processing architecture 300 can pull from a stop position table that defines a stop position of each of the plurality of bolt-on symbols 418B, 418C within each reel 402-410, and/or a stop position table that does not include bolt-on symbol 418A therein. Furthermore, when the gold and silver maps are locked, RNG engine 316 of game processing architecture 300 can pull from another stop position table that defines a stop position of for only bolt-on symbol 418C within each reel 402-410.

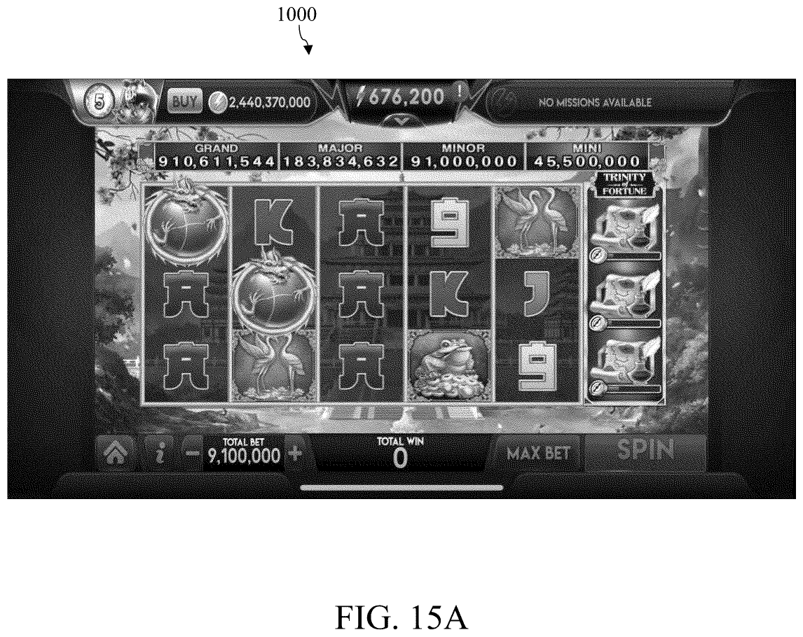

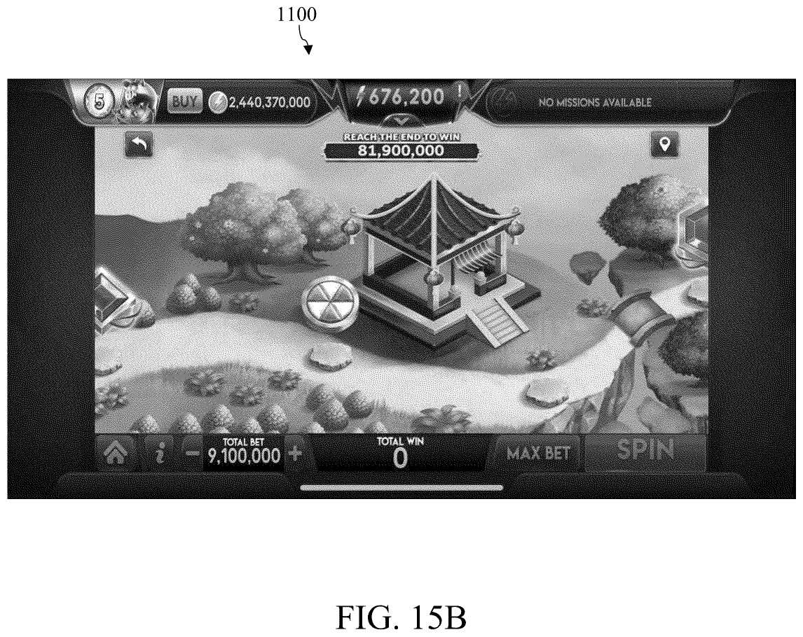

FIG. 15A is an illustrate example screenshot and/or interface 1000 of an electronic game including a base reel game and a bonus map game, as explained herein. Interface 1000 shows an example of the base reel game.

FIG. 15B is an illustrate example screenshot and/or interface 1100 of an electronic game including a base reel game and a bonus map game, as explained herein. Interface 1100 shows an example of the bonus map game.

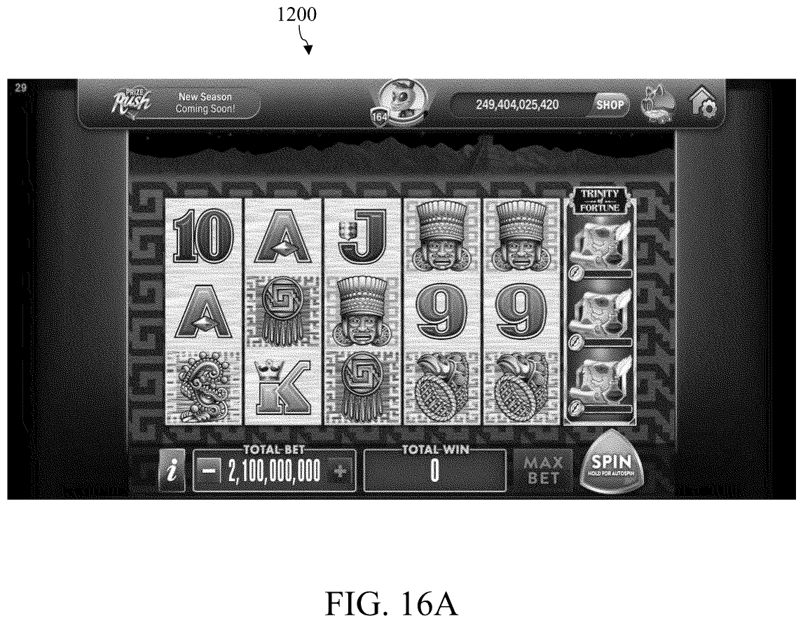

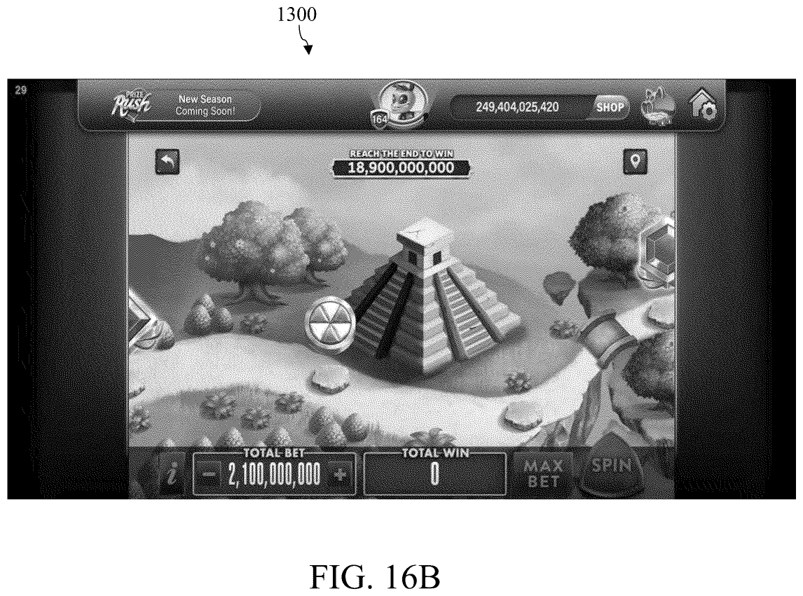

FIG. 16A is an illustrate example screenshot and/or interface 1200 of an electronic game including a base reel game and a bonus map game, as explained herein. Interface 1200 shows another example of the base reel game.

FIG. 16B is an illustrate example screenshot and/or interface 1300 of an electronic game including a base reel game and a bonus map game, as explained herein. Interface 1300 shows another example of the bonus map game.

A computer, controller, or server, such as those described herein, includes at least one processor or processing unit and a system memory. The computer, controller, or server typically has at least some form of computer readable non-transitory media. As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit, and other programmable circuits “configured to” carry out programmable instructions, and these terms are used interchangeably herein. In the implementations described herein, memory may include, but is not limited to, a computer-readable medium or computer storage media, volatile and nonvolatile media, removable and non-removable media implemented in any method or technology for storage of information such as computer readable instructions, data structures, program modules, or other data. Such memory includes a random access memory (RAM), computer storage media, communication media, and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the implementations described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary implementation, additional output channels may include, but not be limited to, an operator interface monitor.

As indicated above, the process may be embodied in computer software. The computer software could be supplied in a number of ways, for example on a tangible, non-transitory, computer readable storage medium, such as on any nonvolatile memory device (e.g. an EEPROM). Further, different parts of the computer software can be executed by different devices, such as, for example, in a client-server relationship. Persons skilled in the art will appreciate that computer software provides a series of instructions executable by the processor.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming system comprising:
at least one memory for storing instructions; and
a game controller in communication with the at least one memory, the game controller including at least one processor, wherein when the instructions are executed by the at least one processor, the at least one processor is configured to:
cause to be displayed on a display device a base reel game including a plurality of reels displaying at least one of: (i) a plurality of game symbols, or (ii) at least one bolt-on symbol associated with one of the plurality of game symbols, the bolt-on symbols associated with instructions stored in the at least one memory subsequent to instructions associated with the base reel game;
determine that an outcome of the base reel game triggers a map game corresponding to the at least one bolt-on symbol displayed on one of the plurality of reels, the map game associated with the instructions stored in the at least one memory subsequent to instructions associated with the base reel game;
cause to be displayed on the display device the map game including a plurality of map spaces, each of the plurality of map spaces associated with one of a plurality of bonus games or a prize value;
define a map game outcome including one map space of the plurality of map spaces of the map game; and
in response to defining the map game outcome, cause to be displayed on the display device one of the plurality of bonus games or the prize value associated with the map space of the plurality of map spaces included in the defined map game outcome.

2. The electronic gaming system of claim 1, wherein the instructions stored in the memory, when executed by the at least one processor, further cause the at least one processor to:
subsequent to causing to display on the display device the map game, cause to be displayed on the display device a wheel including a plurality of wedges, each of the plurality of wedges including a number; and
in response to determining a wheel outcome based on spinning of the wheel including the plurality of wedges, define the map game outcome including the one map space of the plurality of map spaces, the one map space included in the map game outcome based on the number included in the determined wheel outcome.

3. The electronic gaming system of claim 1, wherein the plurality of bonus games include:
a bonus wheel game;
a hold-and-spin game;
a pick bonus game; and
a free spin bonus game.

4. The electronic gaming system of claim 1, wherein the instructions stored in the memory, when executed by the at least one processor, further cause the at least one processor to:
determine the map game outcome includes a final map space included in the plurality of map spaces for the map game; and
cause to be displayed on the display device a map completion prize value associated with the final map space of the map game.

5. The electronic gaming system of claim 4, wherein the instructions stored in the memory, when executed by the at least one processor, further cause the at least one processor to:
subsequent to causing to display on the display device the map completion prize value, cause to display on the display device the base reel game; and
in response to determining a subsequent outcome of the base reel game retriggers the map game, cause to be displayed on the display device the map game including a starting map space included in the plurality of map spaces for the map game.

6. The electronic gaming system of claim 1, wherein the instructions stored in the memory, when executed by the at least one processor, further cause the at least one processor to:
cause to be displayed on the display device a map game progress indicator during the base reel game; and
in response to determining the outcome of the base reel game triggers includes the at least one bolt-on symbol displayed on one of the plurality of reels, adjust the map game progress indicator.

7. The electronic gaming system of claim 1, wherein the instructions stored in the memory, when executed by the at least one processor, further cause the at least one processor to:
cause to be displayed on the display device the base reel game including the plurality of reels displaying at least one distinct bolt-on symbol associated with one of the plurality of game symbols;
determine that the outcome of the base reel game triggers a distinct map game corresponding to the at least one distinct bolt-on symbol displayed on one of the plurality of reels;
cause to be displayed on the display device the distinct map game including a plurality of distinct map spaces, each of the plurality of distinct map spaces associated with one of the plurality of bonus games or a distinct prize value;
define a distinct map game outcome including one distinct map space of the plurality of distinct map spaces of the distinct map game; and
in response to defining the distinct map game outcome, cause to be displayed on the display device one of the plurality of bonus games or the distinct prize value associated with the one distinct map space of the plurality of distinct map spaces included in the distinct map game outcome.

8. A method of electronic gaming implemented on an electronic gaming machine, the method comprising:
causing to be displayed on a display device a base reel game including a plurality of reels displaying at least one of: (i) a plurality of game symbols, or (ii) at least one bolt-on symbol associated with one of the plurality of game symbols, the bolt-on symbols associated with instructions stored in at least one memory subsequent to instructions associated with the base reel game;
determining that an outcome of the base reel game triggers a map game corresponding to the at least one bolt-on symbol displayed on one of the plurality of reels, the map game associated with the instructions stored in the at least one memory subsequent to instructions associated with the base reel game;
causing to be displayed on the display device the map game including a plurality of map spaces, each of the plurality of map spaces associated with one of a plurality of bonus games or a prize value;
defining a map game outcome including one map space of the plurality of map spaces of the map game; and
in response to defining the map game outcome, causing to be displayed on the display device one of the plurality of bonus games or the prize value associated with the map space of the plurality of map spaces included in the defined map game outcome.

9. The method of claim 8, further comprising:
subsequent to causing to display on the display device the map game, causing to be displayed on the display device a wheel including a plurality of wedges, each of the plurality of wedges including a number; and
in response to determining a wheel outcome based on spinning of the wheel including the plurality of wedges, defining the map game outcome including the one map space of the plurality of map spaces, the one map space included in the map game outcome based on the number included in the determined wheel outcome.

10. The method of claim 8, wherein the plurality of bonus games include:
a bonus wheel game;
a hold-and-spin game;
a pick bonus game; and
a free spin bonus game.

11. The method of claim 8, further comprising:
determining the map game outcome includes a final map space included in the plurality of map spaces for the map game; and
causing to be displayed on the display device a map completion prize value associated with the final map space of the map game.

12. The method of claim 11,
subsequent to causing to display on the display device the map completion prize value, causing to display on the display device the base reel game; and
in response to determining a subsequent outcome of the base reel game retriggers the map game, causing to be displayed on the display device the map game including a starting map space included in the plurality of map spaces for the map game.

13. The method of claim 8, further comprising:
causing to be displayed on the display device a map game progress indicator during the base reel game; and
in response to determining the outcome of the base reel game triggers includes the at least one bolt-on symbol displayed on one of the plurality of reels, adjusting the map game progress indicator.

14. The method of claim 8, further comprising:
causing to be displayed on the display device the base reel game including the plurality of reels displaying at least one distinct bolt-on symbol associated with one of the plurality of game symbols;
determining that the outcome of the base reel game triggers a distinct map game corresponding to the at least one distinct bolt-on symbol displayed on one of the plurality of reels;
causing to be displayed on the display device the distinct map game including a plurality of distinct map spaces, each of the plurality of distinct map spaces associated with one of the plurality of bonus games or a distinct prize value;
defining a distinct map game outcome including one distinct map space of the plurality of distinct map spaces of the distinct map game; and
in response to defining the distinct map game outcome, causing to be displayed on the display device one of the plurality of bonus games or the distinct prize value associated with the one distinct map space of the plurality of distinct map spaces included in the distinct map game outcome.

15. A non-transitory computer-readable storage medium with instructions stored thereon that, in response to execution by at least one processor, cause the at least one processor to:
cause to be displayed on a display device a base reel game including a plurality of reels displaying at least one of: (i) a plurality of game symbols, or (ii) at least one bolt-on symbol associated with one of the plurality of game symbols, the bolt-on symbols associated with instructions stored in at least one memory subsequent to instructions associated with the base reel game;
determine that an outcome of the base reel game triggers a map game corresponding to the at least one bolt-on symbol displayed on one of the plurality of reels, the map game associated with the instructions stored in the at least one memory subsequent to instructions associated with the base reel game;
cause to be displayed on the display device the map game including a plurality of map spaces, each of the plurality of map spaces associated with one of a plurality of bonus games or a prize value;
define a map game outcome including one map space of the plurality of map spaces of the map game; and
in response to defining the map game outcome, cause to be displayed on the display device one of the plurality of bonus games or the prize value associated with the map space of the plurality of map spaces included in the defined map game outcome.

16. The non-transitory computer-readable storage medium of claim 15, wherein the instructions, when executed, further cause the at least one processor to:
subsequent to causing to display on the display device the map game, cause to be displayed on the display device a wheel including a plurality of wedges, each of the plurality of wedges including a number; and
in response to determining a wheel outcome based on spinning of the wheel including the plurality of wedges, define the map game outcome including the one map space of the plurality of map spaces, the one map space included in the map game outcome based on the number included in the determined wheel outcome.

17. The non-transitory computer-readable storage medium of claim 15, wherein the instructions, when executed, further cause the at least one processor to:
determine the map game outcome includes a final map space included in the plurality of map spaces for the map game; and
cause to be displayed on the display device a map completion prize value associated with the final map space of the map game.

18. The non-transitory computer-readable storage medium of claim 17, wherein the instructions, when executed, further cause the at least one processor to:
subsequent to causing to display on the display device the map completion prize value, cause to display on the display device the base reel game; and
in response to determining a subsequent outcome of the base reel game retriggers the map game, cause to be displayed on the display device the map game including a starting map space included in the plurality of map spaces for the map game.

19. The non-transitory computer-readable storage medium of claim 15, wherein the instructions, when executed, further cause the at least one processor to:
cause to be displayed on the display device a map game progress indicator during the base reel game; and
in response to determining the outcome of the base reel game triggers includes the at least one bolt-on symbol displayed on one of the plurality of reels, adjust the map game progress indicator.

20. The non-transitory computer-readable storage medium of claim 15, wherein the instructions, when executed, further cause the at least one processor to:
cause to be displayed on the display device the base reel game including the plurality of reels displaying at least one distinct bolt-on symbol associated with one of the plurality of game symbols;
determine that the outcome of the base reel game triggers a distinct map game corresponding to the at least one distinct bolt-on symbol displayed on one of the plurality of reels;
cause to be displayed on the display device the distinct map game including a plurality of distinct map spaces, each of the plurality of distinct map spaces associated with one of the plurality of bonus games or a distinct prize value;
define a distinct map game outcome including one distinct map space of the plurality of distinct map spaces of the distinct map game; and
in response to defining the distinct map game outcome, cause to be displayed on the display device one of the plurality of bonus games or the distinct prize value associated with the one distinct map space of the plurality of distinct map spaces included in the distinct map game outcome.
